(19) United States
(12) Patent Application Publication
(10) Pub. No.: US 2020/0242730 A1
(43) Pub. Date: Jul. 30, 2020

(54) IMAGE PROCESSING METHOD, SEMICONDUCTOR DEVICE, AND ELECTRONIC DEVICE

(71) Applicant: SEMICONDUCTOR ENERGY LABORATORY CO., LTD., Atsugi-shi, Kanagawa-ken (JP)

(72) Inventors: Masataka SHIOKAWA, Isehara, Kanagawa (JP); Yuki TAMATSUKURI, Atsugi, Kanagawa (JP)

(21) Appl. No.: 16/636,705

(22) PCT Filed: Aug. 23, 2018
(86) PCT No.: PCT/IB2018/056380

§ 371 Date: Feb. 5, 2020

(30) Foreign Application Priority Data
Sep. 4, 2017 (JP) 2017-169609

(51) Int. Cl. G06T 3/40; H04N 7/01

(52) U.S. Cl. CPC G06T 3/40; G06T 2207/20084; H04N 7/0125

(57) ABSTRACT

A semiconductor device which performs upconversion without a large amount of learning data is provided. The semiconductor device increasing the resolution of a first image data to generate a high-resolution image data. It includes the first step of generating a second image data by decreasing the resolution of the first image data, the second step of generating a third image data having a higher resolution than the second image data by inputting the second image data to a neural network, the third step of calculating an error for the third image data relative to the first image data by their comparison, and the fourth step of modifying a weight coefficient of the neural network on the basis of the error; and then the high resolution image data is generated by inputting the first image data into the neural network after a prescribed number of the second to fourth steps.

### TECHNICAL FIELD

One embodiment of the present invention relates to an image processing method, a semiconductor device operated by the image processing method, and an electronic device including the semiconductor device.

Note that in this specification and the like, a semiconductor device generally means a device that can function by utilizing semiconductor characteristics. A display device, a light-emitting device, a memory device, an electro-optical device, a power storage device, a semiconductor circuit, and an electronic device may include the semiconductor device.

Note that one embodiment of the present invention is not limited to the above technical field. The technical field of the invention disclosed in this specification and the like relates to an object, a method, or a manufacturing method. Alternatively, one embodiment of the present invention relates to a process, a machine, manufacture, or a composition of matter. Therefore, more specific examples of the technical field of one embodiment of the present invention disclosed in this specification include a semiconductor device, a display device, a liquid crystal display device, a light-emitting device, a power storage device, an imaging device, a memory device, a processor, an electronic device, a method of driving any of them, a method of manufacturing any of them, a method of inspecting any of them, and their systems.

### BACKGROUND ART

There has been a demand for seeing high-resolution images due to an increase in screen size of televisions (TV). In Japan, 4K practical broadcasting utilizing communication satellite (CS), cable television, and the like started in 2015, and 4K and 8K test broadcasting utilizing broadcast satellite (BS) started in 2016. 8K practical broadcasting is planned to start in the future. Therefore, a variety of electronic devices compatible with 8K broadcasting are being developed (Non-Patent Document 1). In 8K practical broadcasting, there are plans to employ 4K broadcasting and 2K broadcasting (full high vision broadcasting) together.

The resolution (the number of horizontal and perpendicular pixels) of an image in 8K broadcasting is 7680×4320, which is 4 times as high as that of 4K broadcasting (3840×2160) and 16 times as high as that of 2K broadcasting (1920×1080). Therefore, a person who sees an image in 8K broadcasting is expected to be able to feel a higher realistic sensation than a person who sees an image in 2K broadcasting, an image in 4K broadcasting, or the like.

Furthermore, a technique of generating a high-resolution image from a low-resolution image with the use of upconversion has been disclosed (Patent Document 1).

### REFERENCES

### Patent Document

[Patent Document 1] Japanese Published Patent Application No. 2011-180798

### Non-Patent Document

[Non-Patent Document 1] S. Kawashima, et al., “13.3-In. 8K×4K 664-ppi OLED Display Using CAAC-OS FETs.” SID 2014 DIGEST. pp. 627-630.

### SUMMARY OF THE INVENTION

### Problems to be Solved by the Invention

Upconversion can be performed using a neural network, for example. For example, teacher data is prepared and used for neural network's learning, so that the neural network can be configured to have an upconversion function. However, there is a problem that the quality of a high-resolution image generated by upconversion is not high without a prepared large amount of learning data.

In view of the foregoing, an object of one embodiment of the present invention is to provide an image processing method in which upconversion is performed without a large amount of learning data. Alternatively, an object of one embodiment of the present invention is to provide an image processing method which enables the quality of a high-resolution image generated by upconversion to be high. Alternatively, an object of one embodiment of the present invention is to provide an image processing method in which upconversion is performed with a small-scale circuit. Alternatively, an object of one embodiment of the present invention is to provide an image processing method capable of high-speed operation. Alternatively, an object of one embodiment of the present invention is to provide a novel image processing method.

Alternatively, an object of one embodiment of the present invention is to provide a semiconductor device which can perform upconversion without a large amount of learning data. Alternatively, an object of one embodiment of the present invention is to provide a semiconductor device which can perform upconversion so that the image quality of a generated high-resolution image can be high. Alternatively, an object of one embodiment of the present invention is to provide a semiconductor device capable of upconversion with a small-scale circuit. Alternatively, an object of one embodiment of the present invention is to provide a semiconductor device which operates at high speed. Alternatively, an object of one embodiment of the present invention is to provide a novel semiconductor device.

Note that the objects of one embodiment of the present invention are not limited to the objects listed above. The objects listed above do not preclude the existence of other objects. The other objects are objects that are not described in this section and will be described below. The objects that are not described in this section will be derived from the description of the specification, the drawings, or the like and can be extracted from the description as appropriate by those skilled in the art. One embodiment of the present invention achieves at least one of the descriptions given above and the other objects. One embodiment of the present invention need not solve all the aforementioned descriptions and the other objects.

### Means for Solving the Problems

One embodiment of the present invention is an image processing method of increasing the resolution of a first image data and generating a high-resolution image data and is also an image processing method which includes a first step of generating a second image data by decreasing the resolution of the first image data; a second step of generating a third image data having a higher resolution than the second image data by inputting the second image data to a neural network; a third step of calculating an error between the third image data and the first image data by comparing the first image data and the third image data; and a fourth step of modifying a weight coefficient of the neural network on the basis of the error, in which after the second to fourth steps are performed a prescribed number of times, the first image data is input to the neural network to generate the high-resolution image data.

Furthermore, in the above embodiment, the resolution of the third image data may be lower than or equal to the resolution of the first image data.

Furthermore, in the above embodiment, the resolution of the second image data may be 1/m² (m is an integer more than or equal to 2) of the resolution of the first image data, and the resolution of the high-resolution image data may be n² times (n is an integer more than or equal to 2) the resolution of the first image data.

Furthermore, in the above embodiment, m and n may be equal values.

Moreover, one embodiment of the present invention is a semiconductor device which receives a first image data and generates a high-resolution image data obtained by increasing the resolution of the first image data, and is also a semiconductor device including a first circuit, a second circuit, and a third circuit, in which the first circuit is configured to retain the first image data, the first circuit is configured to output the retained first image data to the second circuit, the second circuit is configured to generate a second image data by decreasing the resolution of the first image data and then input the second image data to the third circuit, the third circuit is configured to generate a third image data by increasing the resolution of the second image data, the second circuit is configured to calculate an error between the third image data and the first image data by comparing the first image data and the third image data, the third circuit is configured to modify a parameter of the third circuit on the basis of the error, and the third circuit is configured to generate the high-resolution image data by increasing the resolution of the first image data after the modification of the parameter is performed a prescribed number of times.

Furthermore, in the above embodiment, the third circuit may include a neural network, and the parameter may be a weight coefficient of the neural network.

Furthermore, in the above embodiment, the resolution of the third image data may be lower than or equal to the resolution of the first image data.

Furthermore, in the above embodiment, the resolution of the second image data may be 1/m² (m is an integer more than or equal to 2) of the resolution of the first image data, and the resolution of the high-resolution image data may be n² times (n is an integer more than or equal to 2) the resolution of the first image data.

Furthermore, in the above embodiment, m and n may be equal values.

Moreover, an electronic device which includes the semiconductor device according to one embodiment of the present invention and a display portion is also one embodiment of the present invention.

### Effect of the Invention

With one embodiment of the present invention, an image processing method in which upconversion is performed without a large amount of learning data can be provided. Alternatively, with one embodiment of the present invention, an image processing method which enables the quality of a high-resolution image generated by upconversion to be high can be provided. Alternatively, with one embodiment of the present invention, an image processing method in which upconversion is performed with a small-scale circuit can be provided. Alternatively, with one embodiment of the present invention, an image processing method capable of high-speed operation can be provided. Alternatively, with one embodiment of the present invention, a novel image processing method can be provided.

Alternatively, with one embodiment of the present invention, a semiconductor device which can perform upconversion without a large amount of learning data can be provided. Alternatively, with one embodiment of the present invention, a semiconductor device which can perform upconversion so that the image quality of a generated high-resolution image can be high, can be provided. Alternatively, with one embodiment of the present invention, a semiconductor device capable of upconversion with a small-scale circuit can be provided. Alternatively, with one embodiment of the present invention, a semiconductor device which operates at high speed can be provided. Alternatively, with one embodiment of the present invention, a novel semiconductor device can be provided.

Note that the effects of one embodiment of the present invention are not limited to the effects listed above. The effects listed above do not preclude the existence of other effects. The other effects are effects that are not described in this section and will be described below. The effects that are not described in this section will be derived from the description of the specification, the drawings, or the like and can be extracted from the description as appropriate by those skilled in the art. One embodiment of the present invention has at least one of the effects listed above and the other effects. Accordingly, depending on the case, one embodiment of the present invention does not have the effects listed above in some cases.

### BRIEF DESCRIPTION OF THE DRAWINGS

FIG. 1 Views illustrating an example of an image processing method.

FIG. 2 A flow chart showing an example of an image processing method.

FIG. 3 A view illustrating an example of a hierarchical neural network.

FIG. 4 A view illustrating an example of a hierarchical neural network.

FIG. 5 A view illustrating an example of a hierarchical neural network.

FIG. 6 A flow chart showing an example of an image processing method.

FIG. 7 Views illustrating an example of an image processing method.

FIG. 8 Views illustrating an example of an image processing method.

FIG. 9 Views illustrating an example of an image processing method.

FIG. 10 A block diagram illustrating a configuration example of a transmission device and a reception device.

FIG. 11 A block diagram illustrating a configuration example of a transmission device and a reception device.

FIG. 12 A view illustrating a configuration example of a semiconductor device.

FIG. 13 A view illustrating a configuration example of a memory cell.

FIG. 14 A view illustrating a configuration example of an offset circuit.

FIG. 15 A timing chart showing an example of an operation method of a semiconductor device.

FIG. 16 Views illustrating structure examples of a pixel.

FIG. 17 Views illustrating configuration examples of a pixel circuit.

FIG. 18 A view illustrating a structure example of a display device.

FIG. 19 A view illustrating a structure example of a display device.

FIG. 20 A view illustrating a structure example of a display device.

FIG. 21 A view illustrating a structure example of a display device.

FIG. 22 Views illustrating structure examples of a transistor.

FIG. 23 Views illustrating structure examples of a transistor.

FIG. 24 Views illustrating structure examples of a transistor.

FIG. 25 Views illustrating examples of an electronic device.

FIG. 26 Views showing display results.

### MODE FOR CARRYING OUT THE INVENTION

In this specification and the like, an artificial neural network (ANN, hereinafter referred to as neural network) generally means a model that imitates a biological neural network. In general, a neural network has a structure in which units that imitate neurons are connected to each other through a unit that imitates a synapse.

The strength of connection between synapses (connection between neurons), (also referred to as a weight coefficient), can be changed when the neural network is provided with existing information. The processing for determining the connection strength by providing a neural network with existing information is called “learning” in some cases.

Furthermore, when a neural network in which “learning” is performed (connection strength is determined) is provided with any type of information, new information can be output on the basis of the connection strength. The processing for output of new information on the basis of information provided and the connection strength in a neural network is called “inference” or “recognition” in some cases.

Examples of a neural network model include a Hopfield type, a hierarchical type, and the like. In particular, a neural network with a multilayer structure is referred to as a “deep neural network” (DNN), and machine learning using the deep neural network is referred to as “deep learning”. Note that in DNN, a full connected-neural network (FC-NN), a convolutional neural network (CNN), a recurrent neural network (RNN), and the like are included.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, when a metal oxide is used in a semiconductor layer of a transistor, the metal oxide is referred to as an oxide semiconductor in some cases. In the case where a metal oxide is included in a channel formation region of a transistor having at least one of an amplifying function, a rectifying function, and a switching function, the metal oxide can be referred to as a metal oxide semiconductor, or OS for short. In addition, in the case where an OS FET (or OS transistor) is mentioned, the OS FET can also be referred to as a transistor including a metal oxide or an oxide semiconductor.

An impurity in a semiconductor refers to, for example, elements other than the main elements that compose a semiconductor layer. For instance, an element with a concentration of lower than 0.1 at. % is an impurity. If an impurity is contained, for example, a DOS (Density of States) may be formed in the semiconductor, the carrier mobility may be decreased, or the crystallinity may be decreased. In the case where the semiconductor is an oxide semiconductor, examples of an impurity which changes the characteristics of the semiconductor include Group 1 elements, Group 2 elements, Group 13 elements, Group 14 elements, Group 15 elements, transition metals other than the main components, and the like; specifically, for example, hydrogen (also included in water), lithium, sodium, silicon, boron, phosphorus, carbon, nitrogen, and the like. In the case of an oxide semiconductor, oxygen vacancies may be formed by entry of impurities such as hydrogen, for example. Furthermore, when the semiconductor is silicon, examples of an impurity which changes the characteristics of the semiconductor include oxygen, Group 1 elements except hydrogen, Group 2 elements, Group 13 elements, Group 15 elements, and the like.

In this specification and the like, ordinal numbers such as “first”, “second”, and “third” are used in order to avoid confusion among components. Thus, the terms do not limit the number of components. In addition, the terms do not limit the order of components. For example, in this specification and the like, a “first” component in one embodiment can be a “second” component in the other embodiments or claims. Also, for example, in this specification and the like, a “first” component in one embodiment can be omitted in the other embodiments or claims.

The embodiments are described with reference to the drawings. Note that the embodiments can be implemented in many different modes, and it will be readily appreciated by those skilled in the art that the modes and details can be changed in various ways without departing from the spirit and scope thereof. Thus, the present invention should not be interpreted as being limited to the description of the embodiments. Note that in the structures of the embodiments of the invention, the same portions or portions having similar functions are denoted by the same reference numerals in different drawings, and description thereof is not repeated.

Also, in this specification and the like, terms for describing arrangement such as “over” and “under” are used for convenience in describing a positional relation between components with reference to drawings. Furthermore, the positional relation between components is changed as appropriate in accordance with a direction in which each component is depicted. Therefore, the terms for explaining arrangement are not limited to those described in the specification, and can be changed to other terms as appropriate depending on the situation.

The terms “over” and “under” do not necessarily mean directly over or directly under and directly in contact in the description of positional relationship between components. For example, the expression “an electrode B over an insulating layer A” does not necessarily mean that the electrode B is formed over and directly in contact with the insulating layer A and does not exclude the case where another component is provided between the insulating layer A and the electrode B.

In the drawings, the size, the layer thickness, or the region is shown arbitrarily for convenience of description. Therefore, they are not necessarily limited to the illustrated scale. Note that the drawings are schematically shown for clarity, and embodiments of the present invention are not limited to the shapes, values, or the like shown in the drawings. For example, variation in signal, voltage, or current due to noise or variation in signal, voltage, or current due to a difference in timing, or the like can be included.

Also, in the drawings, some components might not be illustrated for clarity of the drawings.

In the drawings, the same elements, elements having similar functions, elements with the same material, elements formed at the same time, or the like are sometimes denoted by the same reference numerals, and repeated description thereof is omitted in some cases.

In this specification and the like, when describing the connection relation of a transistor, one of a source and a drain is denoted as “one of a source and a drain”, a first electrode, or a first terminal; and the other of the source and the drain is denoted as “the other of the source and the drain”, a second electrode, or a second terminal. This is because the source and the drain of a transistor change depending on the structure, operating conditions, or the like of the transistor. Note that the source or the drain of the transistor can also be referred to as a source (or drain) terminal, a source (or drain) electrode, or the like as appropriate depending on the situation. In this specification and the like, two terminals except a gate are sometimes referred to as a first terminal and a second terminal or as a third terminal and a fourth terminal. In the case where a transistor described in this specification and the like has two or more gates (this structure is sometimes referred to as a dual-gate structure), these gates are referred to as a first gate and a second gate or as a front gate and a back gate in some cases. The term “front gate” can be used interchangeably with a simple term “gate”. The term “back gate” can be used interchangeably with a simple term “gate”. Note that a bottom gate is a terminal that is formed before a channel formation region is formed in fabrication of a transistor, and a “top gate” is a terminal that is formed after a channel formation region is formed in fabrication of a transistor.

A transistor includes three terminals called a gate, a source, and a drain. The gate is a terminal that functions as a control terminal for controlling the conduction state of the transistor. In the two input/output terminals functioning as a source or a drain, depending on the type of the transistor and the level of potential supplied to each of the terminals, one of the two input/output terminals functions as the source and the other functions as the drain. Therefore, the terms source and drain can be used interchangeably in this specification and the like.

Furthermore, in this specification and the like, the terms “electrode” and “wiring” do not functionally limit these components. For example, an “electrode” is sometimes used as part of a “wiring”, and vice versa. Moreover, the terms “electrode” and “wiring” also include the case where a plurality of “electrodes” or “wirings” are formed in an integrated manner and the like.

Furthermore, in this specification and the like, voltage and potential can be interchanged with each other as appropriate. Voltage refers to a potential difference from a reference potential. For example, given that the reference potential is a ground potential, voltage can be rephrased into potential. The ground potential does not necessarily mean 0 V. Note that a potential is relative, and a potential supplied to a wiring or the like is sometimes changed depending on the reference potential.

Note that in this specification and the like, the terms such as “film” and “layer” can be interchanged with each other depending on the case or circumstances. For example, the term “conductive layer” can be changed into the term “conductive film” in some cases. Also, for example, the term “insulating film” can be changed into the term “insulating layer” in some cases. Moreover, depending on the case or circumstances, the terms such as “film” and “layer” can be interchanged with another term without using the terms “film” and “layer”. For example, the term “conductive layer” or “conductive film” can be changed into the term “conductor” in some cases. Also, for example, the term “insulating layer” or “insulating film” can be changed into the term “insulator” in some cases.

Note that in this specification and the like, the terms such as “wiring”, “signal line”, and “power supply line” can be interchanged with each other depending on the case or circumstances. For example, the term “wiring” can be changed into the term “signal line” in some cases. Also, for example, the term “wiring” can be changed into the term such as “power supply line” in some cases. Conversely, the terms such as “signal line” and “power supply line” can be changed into the term “wiring” in some cases. The term such as “power supply line” can be changed into the term such as “signal line” in some cases. Conversely, the term such as “signal line” can be changed into the term “power supply line” in some cases. The term “potential” that is applied to a wiring can be changed into the term such as “signal” depending on circumstances or conditions in some cases. Conversely, the term such as “signal” can be changed into the term “potential” in some cases.

The structure described in each embodiment can be combined with the structures described in the other embodiments as appropriate to constitute one embodiment of the present invention. In addition, in the case where a plurality of structure examples are described in one embodiment, the structure examples can be combined with each other as appropriate.

Note that a content (or part thereof) described in one embodiment can be applied to, combined with, or replaced with at least one of the following: another content (or part thereof) described in the same embodiment and a content (or part thereof) described in one or a plurality of the other embodiments, for example.

Note that a content described in an embodiment is a content in each embodiment that is described with reference to a variety of diagrams or described with text disclosed in the specification.

More drawings can be formed by combining a drawing (or part thereof) described in one embodiment with at least one of the following: another part of the drawing, a different drawing (or part thereof) described in the embodiment, and a drawing (or part thereof) described in one or a plurality of the other embodiments.

### Embodiment 1

In this embodiment, an example of an image processing method of one embodiment of the present invention will be described.

### <Example of Image Processing Method>

One embodiment of the present invention relates to an image processing method of generating high-resolution image data by increasing the resolution of first image data, that is, upconverting the first image data. The image processing is performed with a resolution upconversion circuit; after performing learning, the resolution upconversion circuit upconverts the first image data.

In the case where a learning operation is performed, first, the resolution of the first image data is decreased to generate second image data. Next, the second image data is input to the resolution upconversion circuit, and image data whose resolution is increased to approximately the same as that of the first image data, for example, is generated. Then, the first image data and the image data generated by the resolution upconversion circuit are compared, and an error between the image data generated by the resolution upconversion circuit and the first image data is calculated. Then, parameters of the resolution upconversion circuit are modified on the basis of the error. The above is the description of the learning operation.

After the operation from the generation of the image data whose resolution is increased to approximately the same as that of the first image data, for example, by the resolution upconversion circuit to the modification of the parameters of the resolution upconversion circuit is performed a prescribed number of times, the first image data is input to the resolution upconversion circuit. Thus, the first image data is upconverted and high-resolution image data is generated. After the completion of upconversion, the learning operation is performed again.

Note that the resolution upconversion circuit can have a structure including a neural network, for example. In that case, the parameters of the resolution upconversion circuit can be weight coefficients of the neural network.

Furthermore, the operation from the generation of the image data whose resolution is increased to approximately the same as that of the first image data, for example, by the resolution upconversion circuit to the modification of the parameters of the resolution upconversion circuit may be repeated until the error between the image data generated by the resolution upconversion circuit and the first image data becomes lower than a certain value, for example.

In the above image processing method, the first image data, which is image data to be subjected to upconversion, is used as learning data. Therefore, the resolution upconversion circuit can generate high-resolution and high-image-quality image without the preparation of a large amount of learning data. Furthermore, even if overtraining occurs for example, the image quality of an image obtained by upconversion can be prevented from being lower than that of the case where overtraining does not occur. Moreover, the resolution upconversion circuit can be a small-scale circuit.

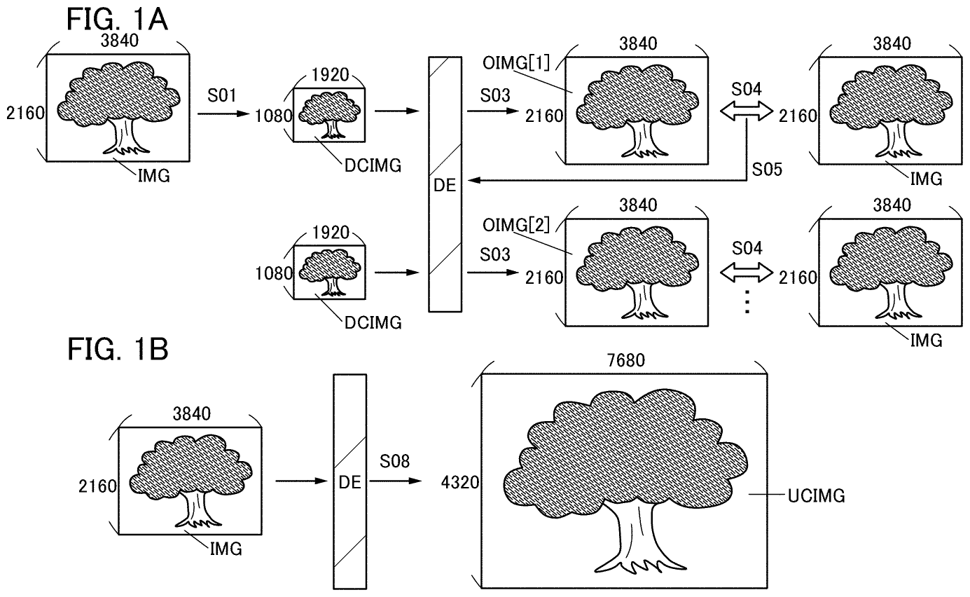

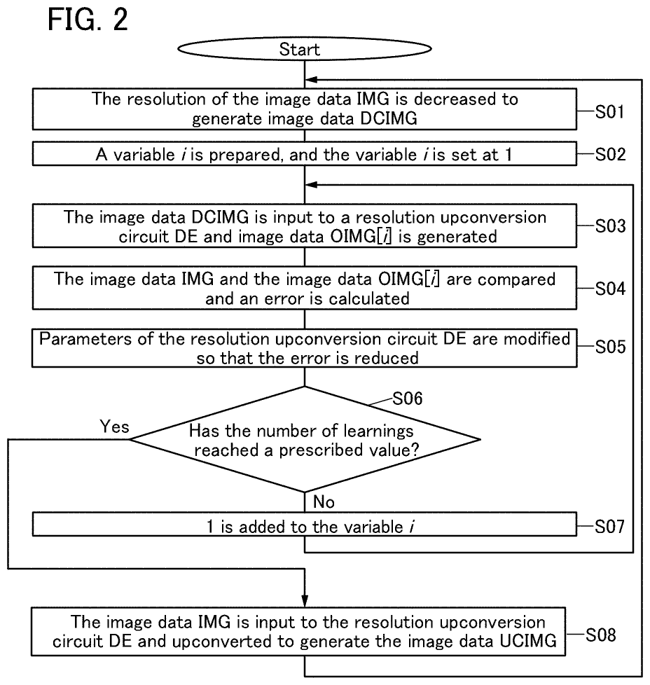

An example of a method for increasing the resolution of image data, which is an image processing method of one embodiment of the present invention, will be described with reference to FIGS. 1(A) and 1(B) and FIG. 2. FIGS. 1(A) and 1(B) are views illustrating a method of upconverting image data IMG with a resolution corresponding to 4K (3840×2160) and generating image data UCIMG with a resolution corresponding to 8K (7680×4320). FIG. 2 is a flow chart showing an example of a method of increasing the resolution of image data.

In the image processing method of one embodiment of the present invention, first, the resolution of the image data IMG is decreased to generate image data DCIMG (Step S01). In FIG. 1(A), the case where the resolution of the image data DCIMG is 1920×1080 is illustrated.

Next, a variable i is prepared, and the variable i is set at 1 (Step S02). Then, the image data DCIMG is input to a resolution upconversion circuit DE having a function of upconverting input image data. Thus, the resolution upconversion circuit DE increases the resolution of the image data DCIMG and generates image data OIMG[i] (Step S03). Since the variable i is 1 here, the resolution upconversion circuit DE increases the resolution of the image data DCIMG and generates image data OIMG[1]. Here, the resolution upconversion circuit DE can perform upconversion by interpolating data that originally does not exist into the input image data. Note that the resolution of the image data OIMG[i] is preferably but not necessarily equivalent to that of the image data IMG. For example, the resolution of the image data OIMG[i] may be lower than that of the image data IMG. In FIG. 1(A), a case where the resolution of the image data OIMG[i] is 3840×2160, which is the same as the resolution of the image data IMG, is illustrated.

The resolution upconversion circuit DE can be a circuit having a neural network, for example. As the neural network, a hierarchical neural network can be used, for example.

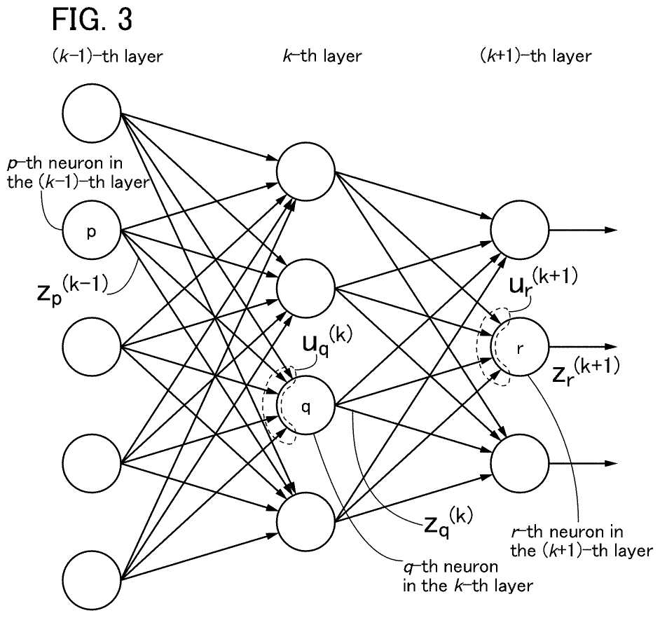

FIG. 3 is a diagram illustrating an example of a hierarchical neural network. A (k−1)-th layer (here, k is an integer greater than or equal to 2) includes P neurons (here, P is an integer greater than or equal to 1), a k-th layer includes Q neurons (here, Q is an integer greater than or equal to 1), and a (k+1)-th layer includes R neurons (here, R is an integer greater than or equal to 1).

The product of an output signal zₚ^{(k-1)} of the p-th neuron (here, p is an integer greater than or equal to 1 and less than or equal to P) in the (k−1)-th layer and a weight coefficient w_{qp}^{(k)} is input to the q-th neuron (here, q is an integer greater than or equal to 1 and less than or equal to Q) in the k-th layer, the product of an output signal z_{q}^{(k)} of the q-th neuron in the k-th layer and a weight coefficient w_{rq}^{(k+1)} is input to the r-th neuron (here, r is an integer greater than or equal to 1 and less than or equal to R) in the (k+1)-th layer; and an output signal of the r-th neuron in the (k+1)-th layer is denoted by z^{(k+1)}.

In this case, the summation u_{q}^{(k)} of signals input to the q-th neuron in the k-th layer is expressed by the following formula.

[Formula 1]

u_{q}^{(k)}=Σw_{qp}^{(k)}zₚ^{(k-1)} (1)

In addition, the output signal z_{q}^{(k)} from the q-th neuron in the k-th layer is defined by the following formula.

[Formula 2]

z_{q}^{(k)}=ƒ(u_{q}^{(k)}) (2)

A function ƒ(u_{q}^{(k)}) is an activation function, and a step function, a linear ramp function, a sigmoid function, or the like can be used. Note that the activation function may be the same or different among all neurons. Additionally, the activation function in one layer may be the same as or different from that in another layer.

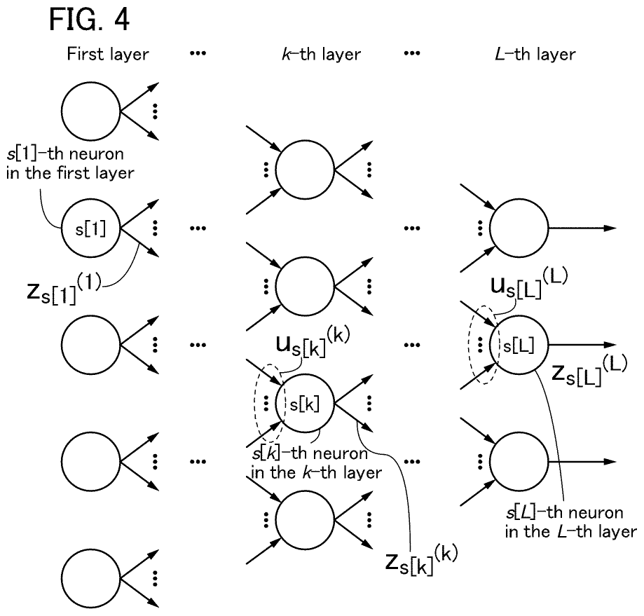

Here, a hierarchical neural network including L layers (here, L is an integer greater than or equal to 3) in total illustrated in FIG. 4 is considered. That is, here, k is an integer greater than or equal to 2 and less than or equal to (L−1). The first layer is an input layer of the hierarchical neural network, the L-th layer is an output layer of the hierarchical neural network, and the second layer to the (L−1)-th layer are hidden layers of the hierarchical neural network.

The first layer (input layer) includes P neurons, the k-th layer (hidden layer) includes Q[k] neurons (Q[k] is an integer greater than or equal to 1), and the L-th layer (output layer) includes R neurons.

When input data is input to the first layer, the first layer can output the input data as it is. That is, the first layer may function as a buffer circuit.

An output signal of the s[1]-th neuron (s[1] is an integer greater than or equal to 1 and less than or equal to P) in the first layer is denoted by z_{s[1]}⁽¹⁾, an output signal of the s[k]-th neuron (s[k] is an integer greater than or equal to 1 and less than or equal to Q[k]) in the k-th layer is denoted by z_{s[k]}^{(k)}, and an output signal of the s[L]-th neuron (s[L] is an integer greater than or equal to 1 and less than or equal to R) in the L-th layer is denoted by z_{s[L]}^{(L)}.

Moreover, the product u_{s[k]}^{(k)} of an output signal z_{s[k-1]}^{(k-1)} of the s[k−1]-th neuron (s[k−1] is an integer greater than or equal to 1 and less than or equal to Q[k−1]) in the (k−1)-th layer and a weight coefficient w_{s[k]s[k-1]}^{(k)} is input to the s[k]-th neuron in the k-th layer, and the product u_{s[L]}^{(L)} of an output signal z_{s[L-1]}^{(L-1)} of the s[L−1]-th neuron (s[L−1] is an integer greater than or equal to 1 and less than or equal to Q[L−1]) in the (L−1)-th layer and a weight coefficient w_{s[L]s[L-1]}^{(L)} is input to the s[L]-th neuron in the L-th layer.

Next, learning will be described. Learning refers to an operation of updating all weight coefficients of a hierarchical neural network on the basis of an output result and a desired result (also referred to as learning data) when the output result and the desired result differ from each other, in the above-described hierarchical neural network function. Here, the learning data can be the image data IMG.

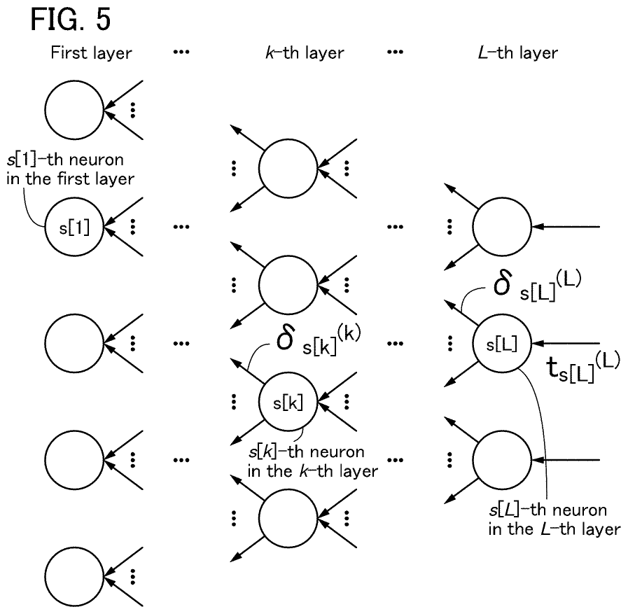

A backpropagation method will be described as a specific example of the above-described learning. FIG. 5 is a view illustrating a learning method using a backpropagation method. The backpropagation method is a method of modifying a weight coefficient so that an error between an output of a hierarchical neural network and learning data becomes small.

For example, assume that input data is input to the s[1]-th neuron in the first layer and output data z_{s[L]}^{(L)} is output from the s[L]-th neuron in the L-th layer. Here, when learning data for the output data z_{s[L]}^{(L)} is t_{s[L]}^{(L)}, error energy E can be expressed using the output data z_{s[L]}^{(L)} and learning data t_{s[L]}^{(L)}.

The update amount of the weight coefficient w_{s[k]s[k-1]}^{(k)} of the s[k]-th neuron in the k-th layer with respect to the error energy E is set to ∂E/∂w_{s[k]s[k-1]}^{(k)}, whereby the weight coefficient can be updated. Here, when an error δ_{s[k]}^{(k)} Of the output value z_{s[k]}^{(k)} of the s[k]-th neuron in the k-th layer is defined as ∂E/∂u_{s[k]}^{(k)}, δ_{s[k]}^{(k)} and ∂E/∂w_{s[k]s[k-1]}^{(k)} can be expressed by the following respective formulae. Note that ƒ(u_{s[k]}^{(k)}) is the derived function of an activation function.

$$\begin{matrix}[ Formula 3 ] & \\ {δ}_{s [ k ]}^{( k )} = {\sum }_{s [ k + 1 ]} {δ}_{s [ k + 1 ]}^{( k + 1 )} \cdot {w}_{s [ k + 1 ] s [ k ]}^{( k + 1 )} \cdot {f}^{′} ( {u}_{s [ k ]}^{( k )} ) & ( 3 ) \\ [ Formula 4 ] & \\ \frac{\partial E}{\partial {w}_{s [ k ] s [ k - 1 ]}^{( k )}} = {δ}_{s [ k ]}^{( k )} \cdot {z}_{s [ k - 1 ]}^{( k - 1 )} & ( 4 )\end{matrix}$$

Here, when the (k+1)-th layer is an output layer, that is, when the (k+1)-th layer is the L-th layer, δ_{s[L]}^{(L)} and ∂/∂w_{s[L]s[L-1]}^{(L)} can be expressed by the following respective formulae.

$$\begin{matrix}[ Formula 5 ] & \\ {δ}_{s [ L ]}^{( L )} = ( {z}_{s [ L ]}^{( L )} - {t}_{s [ L ]} ) \cdot {f}^{′} ( {u}_{s [ L ]}^{( L )} ) & ( 5 ) \\ [ Formula 6 ] & \\ \frac{\partial E}{\partial {w}_{s [ L ] s [ L - 1 ]}^{( L )}} = {δ}_{s [ L ]}^{( L )} \cdot {z}_{s [ L - 1 ]}^{( L - 1 )} & ( 6 )\end{matrix}$$

That is to say, the errors δs[k]^{(k)} and δ_{s[L]}^{(L)} Of all neurons can be obtained by Formula (1) to Formula (6). Note that the update amounts of weight coefficients are set on the basis of the errors δ_{s[k]}^{(k)} and δ_{s[L]}^{(L)}, desired parameters, and the like.

After Step S03 shown in FIG. 1(A) and FIG. 2 is finished, the image data IMG and the image data OIMG[i] generated by the resolution upconversion circuit DE are compared with each other and an error between the image data OIMG[i] and the image data IMG is calculated (Step S04). Since the variable i is 1 here, the image data IMG and the image data OIMG[1] generated by the resolution upconversion circuit DE are compared with each other and an error between the image data OIMG[1] and the image data IMG is calculated. Parameters of the resolution upconversion circuit DE are modified so that the calculated error is reduced (Step S05). As the parameters, weight coefficients can be used, for example. For example, in the case where the resolution upconversion circuit DE includes a neural network and learning is performed using a backpropagation method, the weight coefficients are modified so as to reduce the error between the image data OIMG[i] output from the resolution upconversion circuit DE and the image data IMG, which is learning data.

Next, whether the number of learnings, that is, the number of times Step S03 to Step S05 are performed has reached a prescribed value is determined (Step S06). If it has not reached the prescribed value, 1 is added to the variable i (Step S07), and then the operation returns to Step S03. If it has reached the prescribed value, the image data IMG is input to the resolution upconversion circuit DE. Accordingly, the image data IMG is upconverted and the image data UCIMG is generated (Step S08). Then, the operation returns to Step S01. The above is the description of the image processing method of one embodiment of the present invention.

In the image processing method of one embodiment of the present invention, the image data IMG is used as learning data, and the resolution upconversion circuit DE performs learning according to the procedure shown in Step S01 to Step S07 in FIG. 1(A) and FIG. 2. After the learning, that is, after the number of learnings has reached the prescribed value, the resolution upconversion circuit DE upconverts the image data IMG according to the procedure shown in Step S08 in FIG. 1(B) and FIG. 2. After the completion of upconversion, the resolution upconversion circuit DE performs learning again according to the procedure shown in Step S01 to Step S07 in FIG. 1(A) and FIG. 2.

In the learning method of one embodiment of the present invention, the image data IMG, which is image data to be subjected to upconversion, is used as learning data. Therefore, an image corresponding to the image data UCIMG, which is image data obtained by upconversion, can have high image quality, without the preparation of a large amount of learning data. Furthermore, even if overtraining occurs for example, the image quality of the image corresponding to the image data UCIMG can be prevented from being lower than that of the case where overtraining does not occur. Moreover, the resolution upconversion circuit DE can be a small-scale circuit. For example, in the case where the resolution upconversion circuit DE has a neural network, the number of neurons and the number of hidden layers can be reduced.

Note that although the resolution of the image data DCIMG is ¼ the resolution of the image data IMG in FIG. 1(A), the image processing method of one embodiment of the present invention is not limited thereto. For example, the resolution of the image data DCIMG may be 1/16 the resolution of the image data IMG or 1/64 the resolution of the image data IMG. Alternatively, the resolution of the image data DCIMG may be 1/m² (m is an integer more than or equal to 2) the resolution of the image data IMG.

Furthermore, although the resolution of the image data UCIMG is 4 times the resolution of the image data IMG in FIG. 1(B), the image processing method of one embodiment of the present invention is not limited thereto. For example, the resolution of the image data UCIMG may be 16 times the resolution of the image data IMG or 64 times the resolution of the image data IMG. Alternatively, the resolution of the image data UCIMG may be n² (n is an integer more than or equal to 2) of the resolution of the image data IMG. Here, n and m are preferably equal values because the image data IMG can be precisely upconverted on the basis of the learning result and thus the image corresponding to the image data UCIMG can have high image quality.

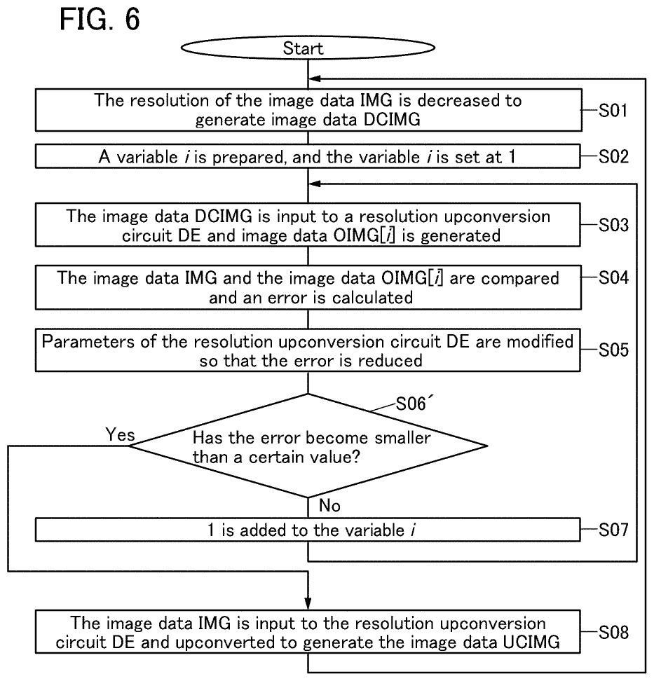

FIG. 2 shows the case where the upconversion of the image data IMG and generation of the image data UCIMG are performed after the number of learnings has reached the prescribed value; however, one embodiment of the present invention is not limited thereto. Instead of determining whether the number of learnings has reached the prescribed value in Step S06, whether the error between the image data OIMG[i] and the image data IMG has become smaller than a certain value is determined in FIG. 6 (Step S06′). If the error is larger than or equal to the certain value, Step S07 is performed. If the error is smaller than the certain value, Step S08 is performed. The method shown in FIG. 6 can prevent upconversion of the image data IMG in the state where the error is large.

In Step S06′, the error can refer to the sum of a total of errors δ_{s[k]}^{(k)} of all neurons provided in the k-th layer (k is an integer greater than or equal to 2 and less than or equal to L−1) illustrated in FIG. 5 and a total of errors δ_{s[L]}^{(L)} of all neurons provided in the L-th layer in FIG. 5, for example. Alternatively, the error can refer to a total of errors δ_{s[L]}^{(L)} of all neurons provided in the L-th layer in FIG. 5.

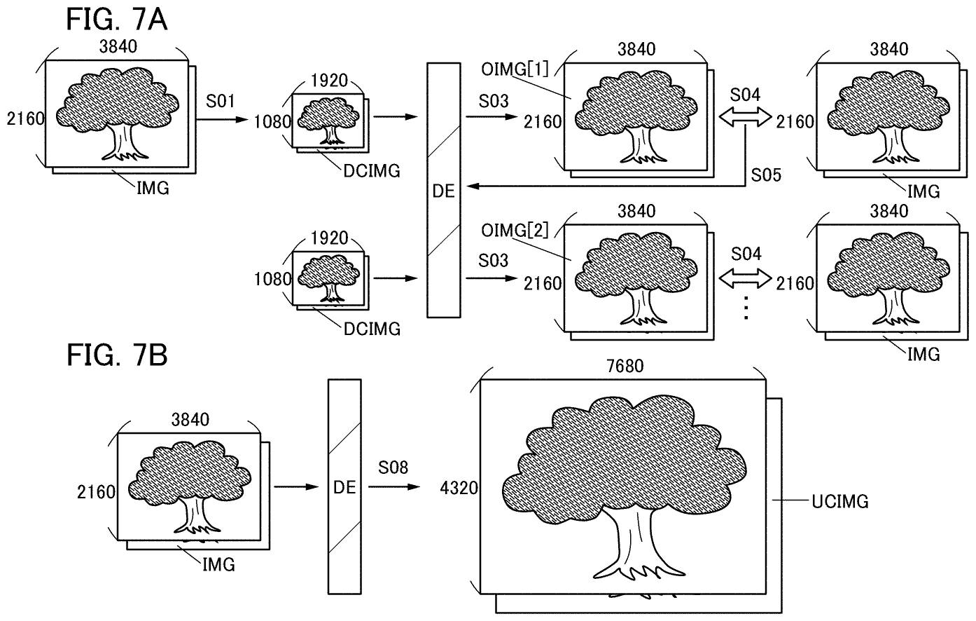

FIG. 7(A) is a view illustrating a learning method in the resolution upconversion circuit DE, which is a variation example of FIG. 1(A). FIG. 7(B) is a view illustrating a method of upconverting the image data IMG, which is a variation example of FIG. 1(B).

FIGS. 1(A) and 1(B) illustrate a case where after learning is performed using the image data IMG corresponding to one sheet of image as learning data, the image data IMG corresponding to one sheet of image is upconverted and the image data UCIMG corresponding to one sheet of image is generated. In contrast, FIGS. 7(A) and 7(B) illustrate a case where after learning is performed using the image data IMG corresponding to two sheets of images as learning data, the image data IMG corresponding to two sheets of images is upconverted and the image data UCIMG corresponding to two sheets of images is generated. After learning is performed using the image data IMG corresponding to three or more sheets of images as learning data, the image data IMG corresponding to three or more sheets of images may be upconverted and the image data UCIMG corresponding to three or more sheets of images may be generated.

In this specification and the like, the term “sheet” in mentioning one sheet of image, two sheets of images, or the like can be rephrased into “frame” in some cases. Furthermore, the term “image” can be rephrased into “still image” in some cases.

The image processing method shown in FIGS. 7(A) and 7(B) can reduce the learning frequency of the resolution upconversion circuit DE. Accordingly, in the case of upconverting a large volume of images such as a moving image in particular, the image processing method of one embodiment of the present invention can be performed at high speed.

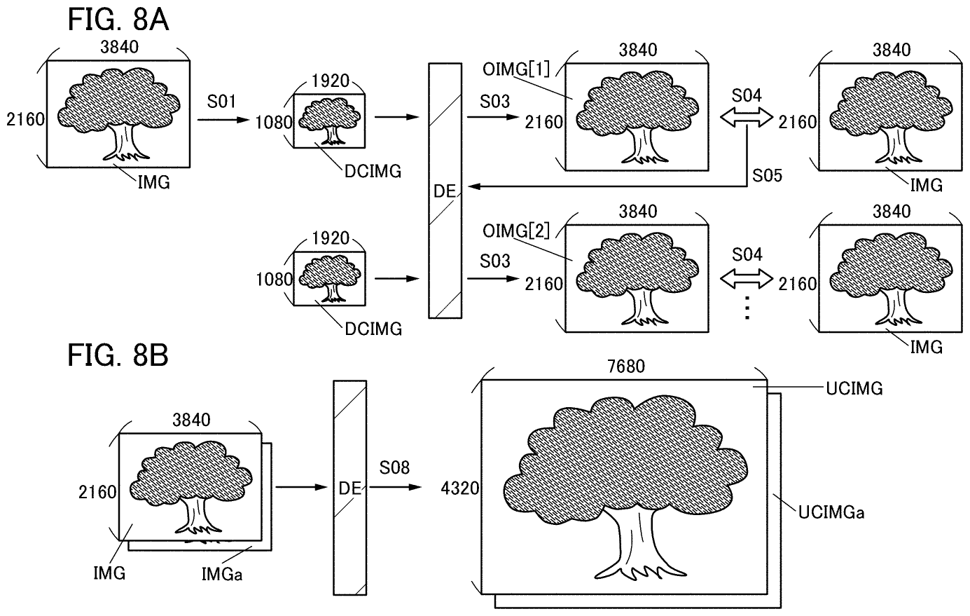

FIG. 8(A) is a view illustrating a learning method in the resolution upconversion circuit DE, and FIG. 8(B) is a view illustrating a method of upconverting the image data IMG. FIGS. 8(A) and 8(B) are variation examples of FIGS. 1(A) and 1(B).

Like FIG. 1(A), FIG. 8(A) illustrates a case where learning is performed using the image data IMG corresponding to one sheet of image as learning data. FIG. 8(B) illustrates a case where not only the image data IMG used as learning data but also image data IMGa, which is not used as learning data, is upconverted. Here, the image data generated by upconversion of the image data IMG is referred to as the image data UCIMG, and the image data generated by upconversion of the image data IMGa is referred to as image data UCIMGa.

In FIGS. 8(A) and 8(B), the image data IMG used as learning data and the image data IMGa, which is not used as learning data, are each image data corresponding to one sheet of image, however, the image processing method of one embodiment of the present invention is not limited thereto. The image data IMG used as learning data may correspond to two or more sheets of images, or the image data IMGa, which is not used as learning data, may correspond to two or more sheets of images.

With the image processing method illustrated in FIGS. 8(A) and 8(B), the learning frequency of the resolution upconversion circuit DE can be reduced without an increase in the number of learning data. Accordingly, in the case of upconverting a large volume of images, the image processing method of one embodiment of the present invention can be performed at high speed.

Here, the image data IMG and the image data IMGa preferably have the smallest possible difference therebetween, that is, are preferably similar image data. Therefore, it is preferable to use the image processing method illustrated in FIGS. 8(A) and 8(B) when a moving image is upconverted, for example. In the case of upconverting a moving image, the image data IMGa can be image data of a frame next to the image data IMG, for example.

Furthermore, after the image data IMGa is upconverted, a difference between the image data IMG and the image data IMGa, which is an upconversion target, may be detected by comparison. For example, in the case where the difference therebetween is smaller than a certain value, upconversion is continuously performed without an additional learning; and in the case where the difference therebetween is larger than or equal to the certain value, learning is performed again. Accordingly, in the case of upconverting a moving image, for example, an additional learning may be performed only when the scene is largely changed. Thus, the image processing method of one embodiment of the present invention can be performed at high speed while a degradation of the image generated by upconversion is suppressed.

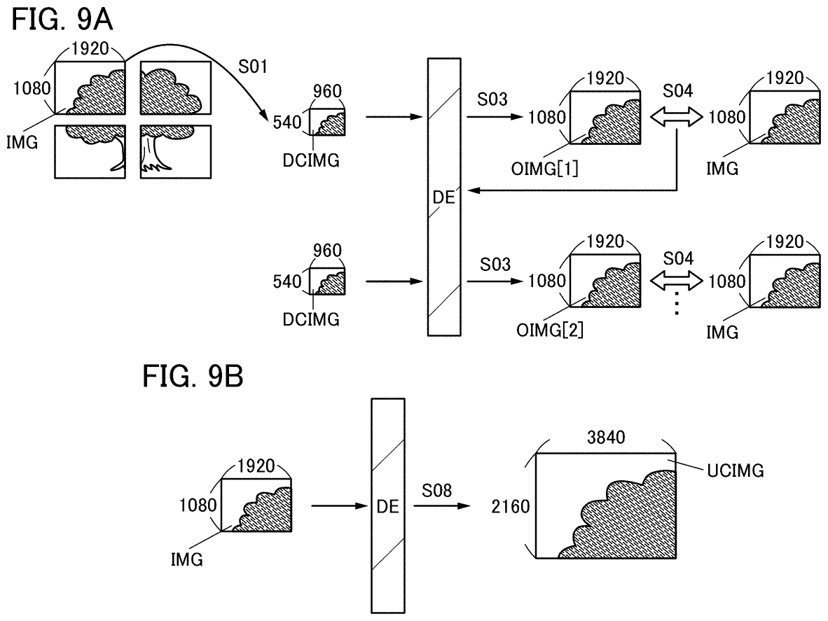

FIG. 9(A) is a view illustrating a learning method in the resolution upconversion circuit DE, which is a variation example of FIG. 1(A). FIG. 9(B) is a view illustrating a method of upconverting the image data IMG, which is a variation example of FIG. 1(B).

FIGS. 9(A) and 9(B) illustrate a case where one sheet of image is divided and image data corresponding to one of pieces into which the one sheet of image is divided is the image data IMG. That is, after the resolution upconversion circuit DE performs learning using, as learning data, the image data corresponding to one of pieces into which the one sheet of image is divided, the image data corresponding to one of pieces into which the one sheet of image is divided is upconverted.

With the image processing method illustrated in FIGS. 9(A) and 9(B), the image data IMG and the image data UCIMG, which is image data obtained by upconversion, can have lower resolutions. Accordingly, the calculation amount needed for learning and upconversion can be reduced. Thus, the image processing method of one embodiment of the present invention can be performed at high speed.

Although the image data IMG is divided into 2×2 image data in the image processing method illustrated in FIGS. 9(A) and 9(B), one embodiment of the present invention is not limited thereto. For example, the image data IMG may be divided into 3×3 image data, 4×4 image data, 10×10 image data, more than 10×10 image data. Furthermore, the number of divisions in the horizontal direction and the number of divisions in the vertical direction may be different from one another. For example, the image data IMG may be divided into 4×3 image data with four image data in the horizontal direction and three image data in the vertical direction.

### <Configuration Example of Transmission Device and Reception Device>

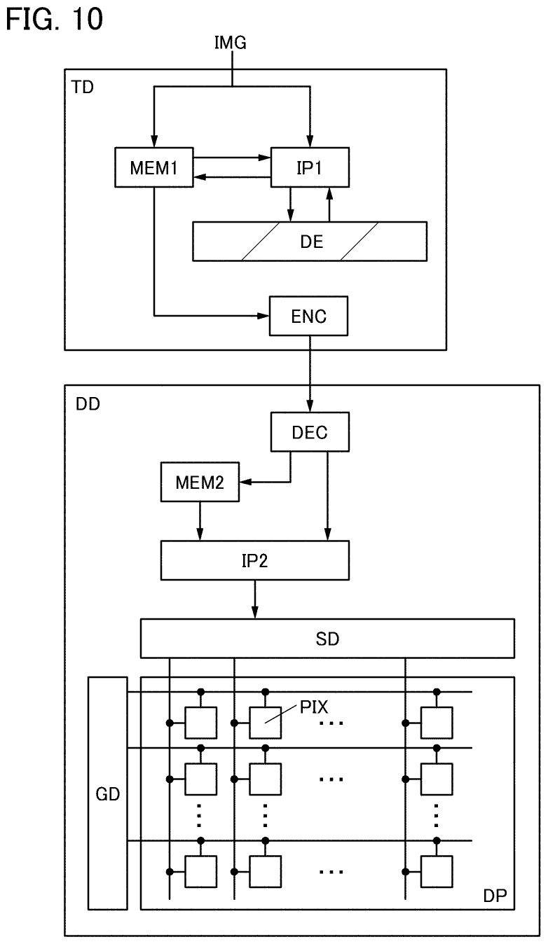

An image processing method of one embodiment of the present invention can be used for a display system, which is a system including a transmission device and a reception device. FIG. 10 is a block diagram illustrating a configuration example of a transmission device TD and a reception device DD which are included in the display system.

In this specification and the like, a transmission device or a reception device may be referred to as a semiconductor device.

The transmission device TD includes a memory circuit MEM1, an image processing circuit IP1, the resolution upconversion circuit DE, and an encoder ENC. The reception device DD includes a decoder DEC, a memory circuit MEM2, an image processing circuit IP2, a gate driver GD, a source driver SD, and a display panel DP. In the display panel DP, pixels PIX are arranged in a matrix. The pixels PIX are electrically connected to the source driver SD by source lines, and to the gate driver GD by gate lines.

That is, the display system having the configuration illustrated in FIG. 10 provides the resolution upconversion circuit DE illustrated in FIGS. 1(A) and 1(B) and the like in the transmission device TD.

The memory circuit MEM1 is configured to retain image data. For example, the memory circuit MEM1 is configured to retain the image data IMG and the image data UCIMG, which is image data obtained by upconversion. Furthermore, the memory circuit MEM1 is configured to output the retained image data to the image processing circuit IP1, the encoder ENC, or the like.

As the memory circuit MEM1, a memory device in which a nonvolatile rewritable memory element is used can be employed, for example. For example, a flash memory, a ReRAM (Resistive Random Access Memory), an MRAM (Magnetoresistive Random Access Memory), a PRAM (Phase change RAM), a FeRAM (Ferroelectric RAM), a NOSRAM (registered trademark), or the like can be used.

Note that a NOSRAM is an abbreviation of “Nonvolatile Oxide Semiconductor RAM”, which refers to a RAM including a gain-cell type (2T-type or 3T-type) memory cell. NOSRAM is a kind of memory that utilizes an OS transistor having a feature of a low off-state current. NOSRAM does not have a limit on the number of rewriting times unlike a flash memory, and the power consumption in writing data is low. Thus, a nonvolatile memory with high reliability and low power consumption can be provided.

Furthermore, as the memory circuit MEM1, a ROM (Read Only Memory) can be used. As the ROM, a mask ROM, an OTPROM (One Time Programmable Read Only Memory), an EPROM (Erasable Programmable Read Only Memory), or the like can be used. As the EPROM, a UV-EPROM (Ultra-Violet Erasable Programmable Read Only Memory) which can erase stored data by ultraviolet irradiation, an EEPROM (Electrically Erasable Programmable Read Only Memory), a flash memory, and the like can be given.

Moreover, as the memory circuit MEM1, a detachable memory device can be used. For example, a storage media drive functioning as a storage device such as a hard disk drive (HDD) or a solid state drive (SSD), a flash memory, a Blu-ray Disc, a DVD, or the like can be used.

The image processing circuit IP1 is configured to perform image processing on image data. For example, the image processing circuit IP1 is configured to perform image processing on the image data IMG supplied from a broadcasting station or the like or the image data IMG retained in the memory circuit MEM1. Furthermore, the image processing circuit IP1 is configured to perform image processing on image data output from the resolution upconversion circuit DE, such as the image data UCIMG.

As the image processing, noise removal processing can be performed, for example. Various noise such as mosquito noise which appears near the outline of characters and the like, block noise which appears in high-speed moving images, random noise causing flicker, and dot noise caused by resolution upconversion can be removed, for example.

Furthermore, the image processing circuit IP1 is configured to decrease the resolution of image data. The decrease of the resolution of the image data IMG can generate the image data DCIMG, for example. In other words, the image processing circuit IP1 can perform Step S01 shown in FIG. 1(A), FIG. 2, and the like.

Furthermore, the image processing circuit IP1 is configured to compare image data from each other and calculate an error. For example, the image processing circuit IP1 is configured to compare the image data IMG and the image data OIMG[i] and calculate an error therebetween. In other words, the image processing circuit IP1 can perform Step S04 shown in FIG. 1(A), FIG. 2, and the like.

Furthermore, the image processing circuit IP1 can be configured to determine whether the number of learnings has reached a prescribed value. In other words, the image processing circuit IP1 can perform Step S06 shown in FIG. 2. Note that the determination of whether the number of learnings has reached the prescribed value can be performed with a counter circuit provided in the image processing circuit IP1.

Furthermore, the image processing circuit IP1 can be configured to determine whether the error has become smaller than a certain value. For example, the image processing circuit IP1 can be configured to determine whether an error between the image data OIMG[i] and the image data IMG has become smaller than a certain value. In other words, the image processing circuit IP1 can perform Step S06′ shown in FIG. 6.

The encoder ENC is configured to encode image data. For example, the encoder ENC is configured to encode the image data UCIMG. Examples of the encoding processing include orthogonal conversion such as discrete cosine transform (DCT) and discrete sine transform (DST), intra-frame prediction, and motion-compensated prediction. The encoder ENC may be configured to perform processing such as addition of data for broadcasting control (e.g., authentication data) to the image data before encoding, encryption, and scrambling (data rearrangement for spread spectrum).

The decoder DEC is configured to decode the encoded image data. Examples of the decoding processing include, like the encoding processing, orthogonal conversion such as DCT and DST, intra-frame prediction, and motion-compensated prediction. The decoder DEC may be configured to perform processing such as frame separation to image data after decoding, decryption of an LDPC (Low Density Parity Check) code, separation of broadcast control data, and descrambling.

The memory circuit MEM2 is configured to retain image data. For example, the memory circuit MEM2 is configured to retain the image data decoded by the decoder DEC. Furthermore, the memory circuit MEM2 is configured to output the retained image data to the image processing circuit IP2 or the like. As the memory circuit MEM2, a memory device that is similar to the memory devices that can be used as the memory circuit MEM1 can be employed.

The image processing circuit IP2 is configured to perform image processing on image data. For example, the image processing circuit IP2 is configured to perform image processing on the image data retained in the memory circuit MEM2 or the image data output from the decoder DEC.

As the image processing, noise removal processing, grayscale conversion processing, tone correction processing, luminance correction processing, or the like can be performed, for example. Examples of the tone correction processing or the luminance correction processing include gamma correction, and the like. As the noise removal processing, processing similar to the processing that the image processing circuit IP1 can perform can be performed.

The grayscale conversion processing converts the grayscale of an image to a grayscale corresponding to output characteristics of the display panel DP. For example, image data which expresses a larger number of gray levels than the number of gray levels that are expressed by the image data input to the image processing circuit IP2 can be generated. In this case, gray level values corresponding to pixels are interpolated to the image data input to the image processing circuit IP2 and assigned to the pixels, so that processing of histogram smoothing can be performed. In addition, high-dynamic range (HDR) processing for increasing a dynamic range is also included in the grayscale conversion processing.

The tone correction processing corrects the tone of an image. The luminance correction processing corrects the brightness (luminance contrast) of an image. For example, a type, luminance, color purity, and the like of a lighting placed in a space where the reception device DD is provided are detected, and luminance and tone of an image displayed on the display panel DP are corrected to be optimal in accordance with the detection. Alternatively, a function of comparing a displayed image to images of various scenes in an image list stored in advance, and then correcting luminance and tone of the displayed image to be suitable for the image of the closest scene can be included.

The gate driver GD is configured to select the pixels PIX. The source driver SD is configured to drive the pixels PIX on the basis of image data. For example, the source driver SD is configured to drive the pixels PIX on the basis of image data output by the image processing circuit IP2. When the pixels PIX are driven by the source driver SD, the image corresponding to the image data UCIMG is displayed on the display panel DP. Furthermore, the source driver SD may be configured to perform D/A conversion on image data.

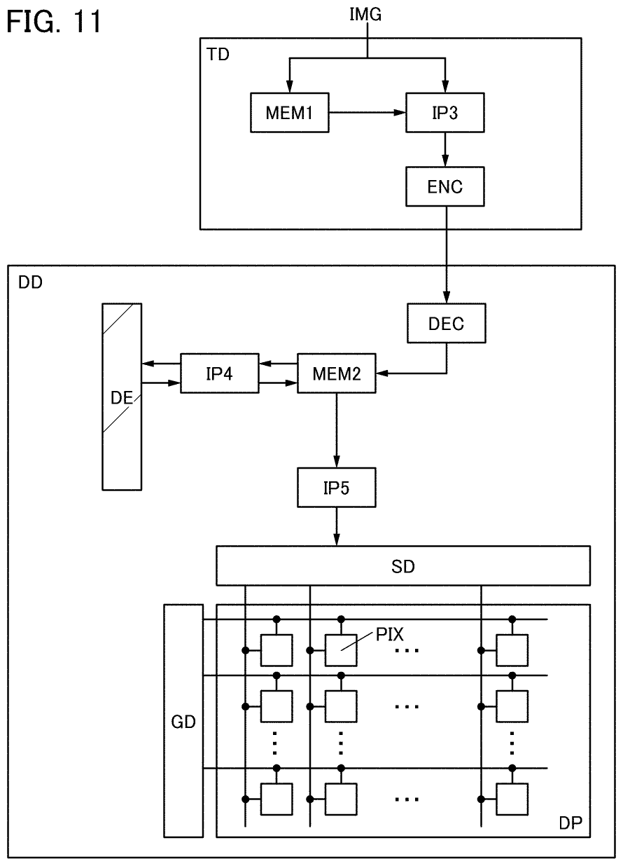

FIG. 11 is a block diagram illustrating a configuration example of the transmission device TD and the reception device DD and is a variation example of the block diagram shown in FIG. 10. The transmission device TD includes the memory circuit MEM1, an image processing circuit IP3, and the encoder ENC. The reception device DD includes the decoder DEC, the memory circuit MEM2, an image processing circuit IP4, the resolution upconversion circuit DE, an image processing circuit IP5, the source driver SD, the gate driver GD, and the display panel DP. The pixels PIX are arranged in a matrix in the display panel DP, as in the reception device DD having the configuration shown in FIG. 10. The pixels PIX are electrically connected to the source driver SD by source lines, and to the gate driver GD by gate lines.

That is, the display system having the configuration shown in FIG. 11 is different from the configuration of the display system shown in FIG. 10 in providing the resolution upconversion circuit DE shown in FIGS. 1(A) and 1(B) and the like in the reception device DD.

In the display system having the configuration shown in FIG. 11, the memory circuit MEM1 can retain the image data IMG. Furthermore, the memory circuit MEM1 can output the retained image data to the image processing circuit IP3 or the like.

Like the image processing circuit IP1 illustrated in FIG. 10, the image processing circuit IP3 is configured to perform image processing, such as noise removal processing, on the image data IMG supplied from a broadcasting station or the like or the image data IMG retained in the memory circuit MEM1, for example. Note that the transmission device TD does not necessarily include the image processing circuit IP3.

Furthermore, the encoder ENC can encode image data output from the image processing circuit IP3. The decoder DEC can decode the image data encoded by the encoder ENC. The memory circuit MEM2 can retain the image data IMG decoded by the decoder DEC and the image data UCIMG, which is the image data obtained by upconversion. Moreover, the memory circuit MEM2 can output the retained image data to the image processing circuit IP4, the image processing circuit IP5, or the like.

Like the image processing circuit IP1, the image processing circuit IP4 is configured to decrease the resolution of image data and is also configured to compare image data from each other and calculate an error. Furthermore, like the image processing circuit IP1, the image processing circuit IP4 may be configured to determine whether the number of learnings has reached a prescribed value and/or whether the error has become smaller than a certain value. Moreover, the image processing circuit IP4 may be configured to perform image processing which is similar to the image processing that can be performed by the image processing circuit IP2 illustrated in FIG. 10.

The image processing circuit IP5 is configured to perform image processing on image data. For example, the image processing circuit IP5 is configured to perform image processing on the image data UCIMG retained in the memory circuit MEM2. As the image processing, noise removal processing, grayscale conversion processing, tone correction processing, luminance correction processing, or the like can be performed, for example, as in the image processing circuit IP2 illustrated in FIG. 10.

Note that in the display systems illustrated in FIG. 10 and FIG. 11, a memory device such as a register, a cache memory, or a main memory may be provided. The memory device can have a structure including a DRAM (Dynamic RAM) or an SRAM (Static RAM). The memory device can be provided in a variety of circuits included in the transmission device TD and a variety of circuits included in the reception device DD, for example. Furthermore, the memory device can be provided in the transmission device TD and the reception device DD as a circuit different from the variety of circuits included in the transmission device TD and the reception device DD.

This embodiment can be combined with the description of the other embodiments as appropriate.

### Embodiment 2

In this embodiment, a structure example of a semiconductor device which can be used in the neural network will be described.

### <Configuration Example of Semiconductor Device>

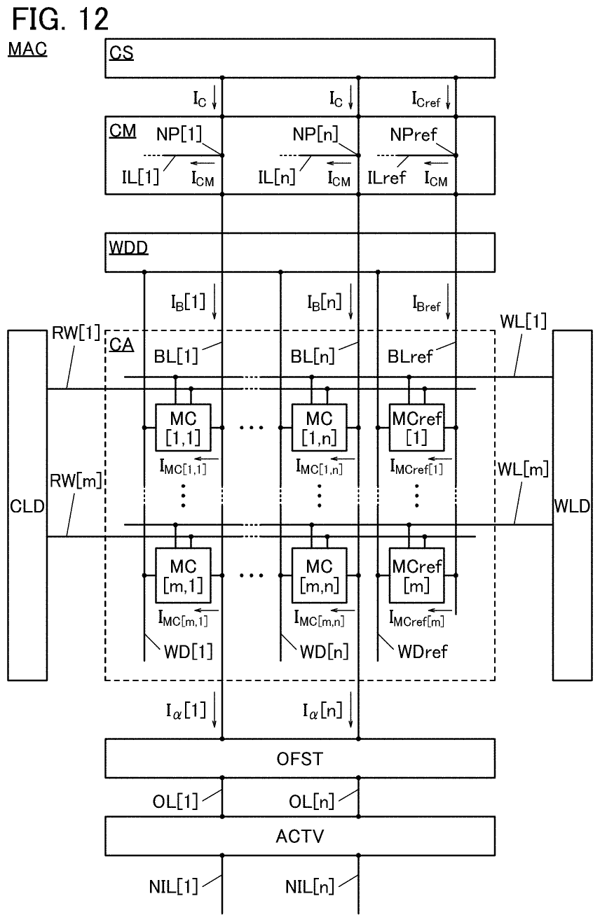

FIG. 12 illustrates a configuration example of a semiconductor device MAC having a function of performing an operation of a neural network. The resolution upconversion circuit DE can have a structure including the semiconductor device MAC.

The semiconductor device MAC is configured to perform a product-sum operation of first data corresponding to weight coefficients of neurons and second data corresponding to input data. Note that the first data and the second data can each be analog data or multilevel data (discrete data). The semiconductor device MAC is also configured to convert data obtained by the product-sum operation with an activation function.

The semiconductor device MAC includes a cell array CA, a current source circuit CS, a current mirror circuit CM, a circuit WDD, a circuit WLD, a circuit CLD, an offset circuit OFST, and an activation function circuit ACTV.

The cell array CA includes a plurality of memory cells MC and a plurality of memory cells MCref. FIG. 12 illustrates a configuration example in which the cell array CA includes the memory cells MC in m rows and n columns (MC[1, 1] to MC[m, n]) and the m memory cells MCref (MCref[1] to MCref[m]) (m and n are integers greater than or equal to 1). The memory cells MC each have a function of storing the first data. In addition, the memory cells MCref each have a function of storing reference data used for the product-sum operation. Note that the reference data can be analog data or multilevel digital data.

The memory cell MC[i, j] (i is an integer greater than or equal to 1 and less than or equal to m, and j is an integer greater than or equal to 1 and less than or equal to n) is connected to a wiring WL[i], a wiring RW[i], a wiring WD[j], and a wiring BL[j]. In addition, the memory cell MCref[i] is connected to the wiring WL[i], the wiring RW[i], a wiring WDref, and a wiring BLref. Here, a current flowing between the memory cell MC[i, j] and the wiring BL[j] is denoted by I_{MC[i,j]}, and a current flowing between the memory cell MCref[i] and the wiring BLref is denoted by I_{MCref[i]}.

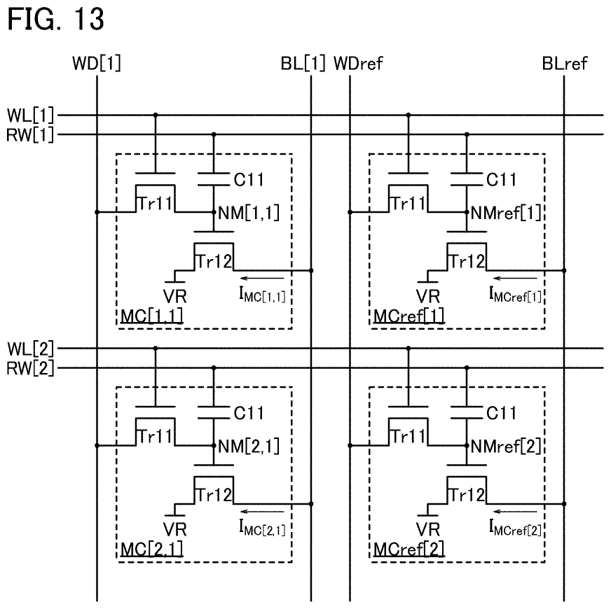

FIG. 13 illustrates a specific configuration example of the memory cells MC and the memory cells MCref. Although the memory cells MC[1, 1] and MC[2, 1] and the memory cells MCref[1] and MCref[2] are illustrated in FIG. 13 as typical examples, similar configurations can be used for other memory cells MC and memory cells MCref. The memory cells MC and the memory cells MCref each include transistors Tr11 and Tr12 and a capacitor C11. Here, the case where the transistor Tr11 and the transistor Tr12 are n-channel transistors will be described.

In the memory cell MC, a gate of the transistor Tr11 is connected to the wiring WL, one of a source and a drain of the transistor Tr11 is connected to a gate of the transistor Tr12 and a first electrode of the capacitor C11, and the other of the source and the drain of the transistor Tr11 is connected to the wiring WD. One of a source and a drain of the transistor Tr12 is connected to the wiring BL, and the other of the source and the drain of the transistor Tr12 is connected to a wiring VR. A second electrode of the capacitor C11 is connected to the wiring RW. The wiring VR is a wiring configured to supply a predetermined potential. Here, the case where a low power supply potential (e.g., a ground potential) is supplied from the wiring VR is described as an example.

A node connected to the one of the source and the drain of the transistor Tr11, the gate of the transistor Tr12, and the first electrode of the capacitor C11 is referred to as a node NM. The nodes NM in the memory cells MC[1, 1] and MC[2, 1] are referred to as nodes NM[1, 1] and NM[2, 1], respectively.

The memory cells MCref have a configuration similar to that of the memory cell MC. However, the memory cells MCref are connected to the wiring WDref instead of the wiring WD and connected to the wiring BLref instead of the wiring BL. Nodes in the memory cells MCref[1] and MCref[2] each of which is connected to the one of the source and the drain of the transistor Tr11, the gate of the transistor Tr12, and the first electrode of the capacitor C11 are referred to as nodes NMref[1] and NMref[2], respectively.

The node NM and the node NMref function as holding nodes of the memory cell MC and the memory cell MCref, respectively. The first data is held in the node NM and the reference data is held in the node NMref. Currents I_{MC[1, 1]} and I_{MC[2, 1]} from the wiring BL[1] flow to the transistors Tr12 of the memory cells MC[1, 1] and MC[2, 11], respectively. Currents I_{MCref[1]} and I_{MCref[2]} from the wiring BLref flow to the transistors Tr12 of the memory cells MCref[1] and MCref[2], respectively.

Since the transistor Tr11 has a function of holding the potential of the node NM or the node NMref, the off-state current of the transistor Tr11 is preferably low. Thus, it is preferable to use an OS transistor, which has extremely low off-state current, as the transistor Tr11. This inhibits a change in the potential of the node NM or the node NMref, so that the operation accuracy can be improved. Furthermore, operations of refreshing the potential of the node NM or the node NMref can be performed less frequently, which leads to a reduction in power consumption.

There is no particular limitation on the transistor Tr12, and for example, a transistor including silicon in a channel formation region (referred to as a Si transistor below), an OS transistor, or the like can be used. In the case where an OS transistor is used as the transistor Tr12, the transistor Tr12 can be manufactured with the same manufacturing apparatus as the transistor Tr11, and accordingly manufacturing cost can be reduced. Note that the transistor Tr12 may be an n-channel transistor or a p-channel transistor.

The current source circuit CS is connected to the wirings BL[1] to BL[n] and the wiring BLref. The current source circuit CS has a function of supplying currents to the wirings BL[1] to BL[n] and the wiring BLref. Note that the value of the current supplied to the wirings BL[1] to BL[n] may be different from the value of the current supplied to the wiring BLref. Here, the current supplied from the current source circuit CS to the wirings BL[1] to BL[n] is denoted by I_{C}, and the current supplied from the current source circuit CS to the wiring BLref is denoted by I_{Cref}.

The current mirror circuit CM includes wirings IL[1] to IL[n] and a wiring ILref. The wirings IL[1] to IL[n] are connected to the wirings BL[1] to BL[n], respectively, and the wiring ILref is connected to the wiring BLref. Here, portions where the wirings IL[1] to IL[n] are connected to the respective wirings BL[1] to BL[n] are referred to as nodes NP[1] to NP[n]. Furthermore, a portion where the wiring ILref is connected to the wiring BLref is referred to as a node NPref.

The current mirror circuit CM has a function of making a current I_{CM} corresponding to the potential of the node NPref flow to the wiring ILref and a function of making this current I_{CM} flow also to the wirings IL[1] to IL[n]. In the example illustrated in FIG. 12, the current I_{CM} is discharged from the wiring BLref to the wiring ILref, and the current I_{CM} is discharged from the wirings BL[1] to BL[n] to the wirings IL[1] to IL[n]. Furthermore, currents flowing from the current mirror circuit CM to the cell array CA through the wirings BL[1] to BL[n] are denoted by I_{B}[1] to I_{B}[n]. Furthermore, a current flowing from the current mirror circuit CM to the cell array CA through the wiring BLref is denoted by I_{Bref}.

The circuit WDD is connected to the wirings WD[1] to WD[n] and the wiring WDref. The circuit WDD has a function of supplying a potential corresponding to the first data to be stored in the memory cells MC to the wirings WD[1] to WD[n]. The circuit WDD also has a function of supplying a potential corresponding to the reference data to be stored in the memory cell MCref to the wiring WDref. The circuit WLD is connected to wirings WL[1] to WL[m]. The circuit WLD has a function of supplying a signal for selecting the memory cell MC or the memory cell MCref to which data is to be written, to any of the wirings WL[1] to WL[m]. The circuit CLD is connected to the wirings RW[1] to RW[m]. The circuit CLD has a function of supplying a potential corresponding to the second data to the wirings RW[1] to RW[m].

The offset circuit OFST is connected to the wirings BL[1] to BL[n] and wirings OL[1] to OL[n]. The offset circuit OFST has a function of detecting the amount of currents flowing from the wirings BL[1] to BL[n] to the offset circuit OFST and/or the amount of change in the currents flowing from the wirings BL[1] to BL[n] to the offset circuit OFST. The offset circuit OFST also has a function of outputting detection results to the wirings OL[1] to OL[n]. Note that the offset circuit OFST may output currents corresponding to the detection results to the wirings OL, or may convert the currents corresponding to the detection results into voltages to output the voltages to the wirings OL. The currents flowing between the cell array CA and the offset circuit OFST are denoted by I_{α}[1] to I_{α}[n].

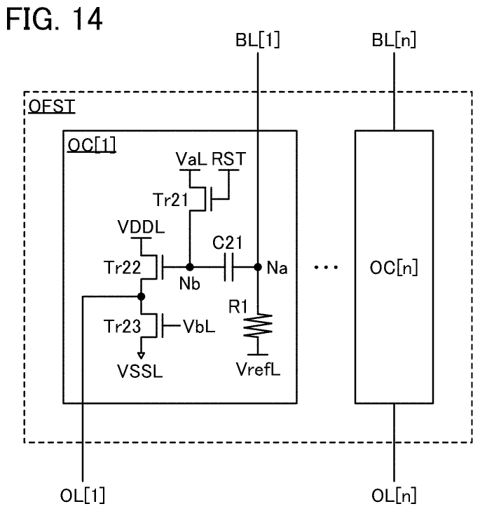

FIG. 14 illustrates a configuration example of the offset circuit OFST. The offset circuit OFST illustrated in FIG. 14 includes circuits OC[1] to OC[n]. The circuits OC[1] to OC[n] each include a transistor Tr21, a transistor Tr22, a transistor Tr23, a capacitor C21, and a resistor R1. Connection relations of the elements are illustrated in FIG. 14. Note that a node connected to a first electrode of the capacitor C21 and a first terminal of the resistor R1 is referred to as a node Na. In addition, a node connected to a second electrode of the capacitor C21, one of a source and a drain of the transistor Tr21, and a gate of the transistor Tr22 is referred to as a node Nb.

A wiring VrefL has a function of supplying a potential Vref, a wiring VaL has a function of supplying a potential Va, and a wiring VbL has a function of supplying a potential Vb. Furthermore, a wiring VDDL has a function of supplying a potential VDD, and a wiring VSSL has a function of supplying a potential VSS. Here, the case where the potential VDD is a high power supply potential and the potential VSS is a low power supply potential is described. A wiring RST has a function of supplying a potential for controlling the conduction state of the transistor Tr21. The transistor Tr22, the transistor Tr23, the wiring VDDL, the wiring VSSL, and the wiring VbL form a source follower circuit.

Next, an operation example of the circuits OC[1] to OC[n] will be described. Note that although an operation example of the circuit OC[1] is described here as a typical example, the circuits OC[2] to OC[n] can operate in a similar manner. First, when a first current flows to the wiring BL[1], the potential of the node Na becomes a potential corresponding to the first current and the resistance value of the resistor R1. At this time, the transistor Tr21 is in an on state, and thus the potential Va is supplied to the node Nb. Then, the transistor Tr21 is brought into an off state.

Next, when a second current flows to the wiring BL[1], the potential of the node Na changes to a potential corresponding to the second current and the resistance value of the resistor R1. At this time, since the transistor Tr21 is in an off state and the node Nb is in a floating state, the potential of the node Nb changes because of capacitive coupling, following the change in the potential of the node Na. Here, when the amount of change in the potential of the node Na is ΔV_{Na} and the capacitive coupling coefficient is 1, the potential of the node Nb is Va+ΔV_{Na}. When the threshold voltage of the transistor Tr22 is Vₜₕ, a potential Va+ΔV_{Na}−Vₜₕ is output from the wiring OL[1]. Here, when Va=Vₜₕ, the potential ΔV_{Na} can be output from the wiring OL[1].

The potential ΔV_{Na} is determined by the amount of change from the first current to the second current, the resistance value of the resistor R1, and the potential Vref. Here, since the resistance value of the resistor R1 and the potential Vref are known, the amount of change in the current flowing to the wiring BL can be found from the potential ΔV_{Na}.

A signal corresponding to the amount of current and/or the amount of change in the current that are/is detected by the offset circuit OFST as described above is input to the activation function circuit ACTV through the wirings OL[1] to OL[n].

The activation function circuit ACTV is connected to the wirings OL[1] to OL[n] and wirings NIL[1] to NIL[n]. The activation function circuit ACTV has a function of performing an operation for converting the signal input from the offset circuit OFST in accordance with the predefined activation function. As the activation function, for example, a sigmoid function, a tanh function, a softmax function, a ReLU function, a threshold function, or the like can be used. The signal converted by the activation function circuit ACTV is output as output data to the wirings NIL[1] to NIL[n].

### <Operation Example of Semiconductor Device>

The product-sum operation of the first data and the second data can be performed using the above semiconductor device MAC. An operation example of the semiconductor device MAC at the time of performing the product-sum operation is described below.

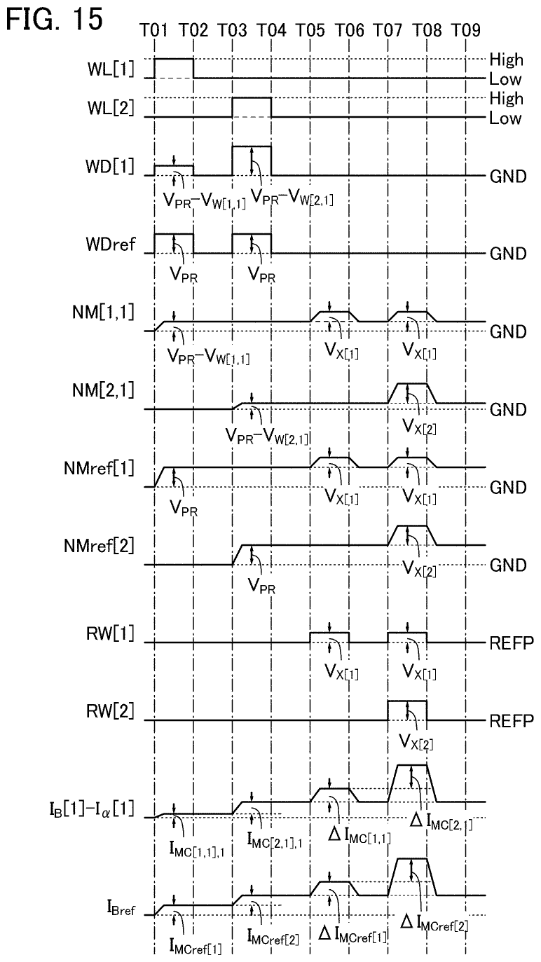

FIG. 15 illustrates a timing chart of the operation example of the semiconductor device MAC. FIG. 15 shows changes in the potentials of the wiring WL[1], the wiring WL[2], the wiring WD[1], the wiring WDref, the node NM[1, 1], the node NM[2, 1], the node NMref[1], the node NMref[2], the wiring RW[1], and the wiring RW[2] in FIG. 13 and changes in the values of a current I_{B}[1]−I_{α}[1] and the current I_{Bref}. The current I_{B}[1]−I_{α}[1] corresponds to the sum total of the currents flowing from the wiring BL[1] to the memory cells MC[1, 1] and MC[2, 1].

Although an operation is described with a focus on the memory cells MC[1, 1] and MC[2, 1] and the memory cells MCref[1] and MCref[2] illustrated in FIG. 13 as a typical example, the other memory cells MC and the other memory cells MCref can be operated in a similar manner.

### [Storage of First Data]

First, in a period from Time T01 to Time T02, the potential of the wiring WL[1] becomes a high level, the potential of the wiring WD[1] becomes a potential greater than a ground potential (GND) by V_{PR}−V_{W[1, 1]}, and the potential of the wiring WDref becomes a potential greater than the ground potential by V_{PR}. The potentials of the wiring RW[1] and the wiring RW[2] become reference potentials (REFP). Note that the potential V_{W[1, 1]} is a potential corresponding to the first data stored in the memory cell MC[1, 1]. The potential V_{PR} is a potential corresponding to the reference data. Thus, the transistors Tr11 included in the memory cell MC[1, 1] and the memory cell MCref[1] are brought into on states, and the potential of the node NM[1, 1] becomes V_{PR}−V_{W[1, 1]} and the potential of the node NMref[1] becomes V_{PR}.

In this case, a current I_{MC[1, 1], 0} flowing from the wiring BL[1] to the transistor Tr12 in the memory cell MC[1, 1] can be expressed by the following formula. Here, k is a constant determined by the channel length, the channel width, the mobility, the capacitance of a gate insulating film, and the like of the transistor Tr12. Furthermore, Vₜₕ is the threshold voltage of the transistor Tr12.

[Formula 7]

I_{MC[1, 1], 0}=k(V_{PR}−V_{W[1, 1]}−Vₜₕ)² (7)

Furthermore, a current I_{MCref[1], 0} flowing from the wiring BLref to the transistor Tr12 in the memory cell MCref[1] can be expressed by the following formula.

[Formula 8]

I_{MCref[1], 0}=k(V_{PR}−Vₜₕ)² (8)

Next, in a period from Time T02 to Time T03, the potential of the wiring WL[1] becomes a low level. Consequently, the transistors Tr11 included in the memory cell MC[1, 1] and the memory cell MCref[1] are brought into off states, and the potentials of the node NM[1, 11] and the node NMref[1] are retained.

As described above, an OS transistor is preferably used as the transistor Tr11. This can suppress the leakage current of the transistor Tr11, so that the potentials of the node NM[1, 1] and the node NMref[1] can be retained accurately.

Next, in a period from Time T03 to Time T04, the potential of the wiring WL[2] becomes the high level, the potential of the wiring WD[1] becomes a potential greater than the ground potential by V_{PR}−V_{W[2, 1]}, and the potential of the wiring WDref becomes a potential greater than the ground potential by V_{PR}. Note that the potential V_{W[2, 1]} is a potential corresponding to the first data stored in the memory cell MC[2, 1]. Thus, the transistors Tr11 included in the memory cell MC[2, 1] and the memory cell MCref[2] are brought into on states, and the potential of the node NM[2, 1] becomes V_{PR}−V_{W[2, 1]} and the potential of the node NMref[2] becomes V_{PR}.

In this case, a current I_{MC[2, 1], 0} flowing from the wiring BL[1] to the transistor Tr12 in the memory cell MC[2, 1] can be expressed by the following formula.

[Formula 9]

I_{MC[}2, 1], 0=k(V_{PR}−V_{W[2, 1]}−Vₜₕ)² (9)

Furthermore, a current I_{MCref[2], 0} flowing from the wiring BLref to the transistor Tr12 in the memory cell MCref[2] can be expressed by the following formula.

[Formula 10]

I_{MCref[2], 0}=k(V_{PR}−Vₜₕ)² (10)

Next, in a period from Time T04 to Time T05, the potential of the wiring WL[2] becomes the low level. Consequently, the transistors Tr11 included in the memory cell MC[2, 1] and the memory cell MCref[2] are brought into off states, and the potentials of the node NM[2, 1] and the node NMref[2] are retained.

Through the above operation, the first data is stored in the memory cells MC[1, 1] and MC[2, 1], and the reference data is stored in the memory cells MCref[1] and MCref[2].

Here, currents flowing through the wiring BL[1] and the wiring BLref in a period from Time T04 to Time T05 are considered. A current is supplied from the current source circuit CS to the wiring BLref. The current flowing through the wiring BLref is discharged to the current mirror circuit CM and the memory cells MCref[1] and MCref[2]. The following formula holds where I_{Cref} is the current supplied from the current source circuit CS to the wiring BLref and I_{CM, 0} is the current discharged from the wiring BLref to the wiring ILref by the current mirror circuit CM.

[Formula 11]

I_{Cref}−I_{CM, 0}=I_{MCref[1], 0}+I_{MCref[2], 0} (11)

A current from the current source circuit CS is supplied to the wiring BL[1]. The current flowing through the wiring BL[1] is discharged to the current mirror circuit CM and the memory cells MC[1] and MC[2, 1]. Furthermore, the current flows from the wiring BL[1] to the offset circuit OFST. The following formula holds where I_{C, 0} is the current supplied from the current source circuit CS to the wiring BL[1] and I_{α, 0} is the current flowing from the wiring BL[1] to the offset circuit OFST

[Formula 12]

I_{C}−I_{CM, 0}=I_{MC[1, 1], 0}+I_{MC[2, 1], 0}+I_{α, 0} (12)

### [Product-Sum Operation of First Data and Second Data]

Next, in a period from Time T05 to Time T06, the potential of the wiring RW[1] becomes a potential greater than the reference potential by V_{X[1]}. At this time, the potential V_{X[1]} is supplied to the capacitor C11 in each of the memory cell MC[1, 1] and the memory cell MCref[1], so that the potential of the gate of the transistor Tr12 is increased because of capacitive coupling. Note that the potential V_{X[1]} is a potential corresponding to the second data supplied to the memory cell MC[1, 1] and the memory cell MCref[1].

The amount of change in the potential of the gate of the transistor Tr12 corresponds to the value obtained by multiplying the amount of change in the potential of the wiring RW by a capacitive coupling coefficient determined by the memory cell configuration. The capacitive coupling coefficient is calculated using the capacitance of the capacitor C11, the gate capacitance of the transistor Tr12, the parasitic capacitance, and the like. In the following description, for convenience, the amount of change in the potential of the wiring RW is equal to the amount of change in the potential of the gate of the transistor Tr12, that is, the capacitive coupling coefficient is 1. In practice, the potential V_{X} can be determined in consideration of the capacitive coupling coefficient.

When the potential V_{X[1]} is supplied to the capacitors C11 in the memory cell MC[1, 1] and the memory cell MCref[1], the potentials of the node NM[1, 1] and the node NMref[1] each increase by V_{X[}1].

Here, a current I_{MC[1, 1]} flowing from the wiring BL[1] to the transistor Tr12 in the memory cell MC[1, 1] in a period from Time T05 to Time T06 can be expressed by the following formula.

[Formula 13]

I_{MC[1, 1], 1}=k(V_{PR}−V_{W[1, 1]}+V_{X[1]}−Vₜₕ)² (13)

That is, when the potential V_{X[1]} is supplied to the wiring RW[1], the current flowing from the wiring BL[1] to the transistor Tr12 in the memory cell MC[1, 1] increases by ΔI_{MC[1, 1]}=I_{MC[1, 1], 1}−I_{MC[1, 1], 0}.

A current I_{MCref[1], 1} flowing from the wiring BLref to the transistor Tr12 in the memory cell MCref[1] in a period from Time T05 to Time T06 can be expressed by the following formula.

[Formula 14]

I_{MCref[1], 1}=k(V_{PR}+V_{X[1]}−Vₜₕ)² (14)

That is, when the potential V_{X[1]} is supplied to the wiring RW[1], the current flowing from the wiring BLref to the transistor Tr12 in the memory cell MCref[1] increases by ΔI_{MCref}[1]=I_{MCref[1], 1}−I_{MCref[1], 0}.

Furthermore, currents flowing through the wiring BL[1] and the wiring BLref are considered. The current I_{Cref} is supplied from the current source circuit CS to the wiring BLref. The current flowing through the wiring BLref is discharged to the current mirror circuit CM and the memory cells MCref[1] and MCref[2]. The following formula holds where I_{CM, 1} is the current discharged from the wiring BLref to the current mirror circuit CM.

[Formula 15]

I_{Cref}−I_{CM, 1}=I_{MCref[1], 1}+I_{MCref[2], 1} (15)

The current I_{C} from the current source circuit CS is supplied to the wiring BL[1]. The current flowing through the wiring BL[1] is discharged to the current mirror circuit CM and the memory cells MC[1, 1] and MC[2, 1]. Furthermore, the current flows from the wiring BL[1] to the offset circuit OFST The following formula holds where I_{α, 1} is the current flowing from the wiring BL[1] to the offset circuit OFST

[Formula 16]

I_{C}−I_{CM, 1}=I_{MC[1, 1], 1}+I_{MC[2, 1], 1}+I_{α, 1} (16)

In addition, from the formulae (7) to (16), a difference between the current I_{α, 0} and the current I_{α, 1} (differential current ΔI_{α}) can be expressed by the following formula.

[Formula 17]

ΔI_{α}=I_{α, 1}−I_{α, 0}=2kV_{W[1, 1]}V_{X[1]} (17)

Thus, the differential current ΔI_{α} is a value corresponding to the product of the potentials V_{W[1, 1]} and V_{X[1].}

After that, in a period from Time T06 to Time T07, the potential of the wiring RW[1] becomes the reference potential, and the potentials of the node NM[1, 1] and the node NMref[1] become similar to those in a period from Time T04 to Time T05.

Next, in a period from Time T07 to Time T08, the potential of the wiring RW[1] becomes a potential greater than the reference potential by V_{X[1], and the potential of the wiring RW[}2] becomes a potential greater than the reference potential by V_{X[2]}. Accordingly, the potential V_{X[1]} is supplied to the capacitor C11 in each of the memory cell MC[1, 1] and the memory cell MCref[1], and the potentials of the node NM[1, 1] and the node NMref[1] each increase by V_{X[1]} because of capacitive coupling. Furthermore, the potential V_{X[2]} is supplied to the capacitor C11 in each of the memory cell MC[2, 1] and the memory cell MCref[2], and the potentials of the node NM[2, 1] and the node NMref[2] each increase by V_{X[2]} because of capacitive coupling.

Here, a current I_{MC[2, 1], 1} flowing from the wiring BL[1] to the transistor Tr12 in the memory cell MC[2, 1] in a period from Time T07 to Time T08 can be expressed by the following formula.

[Formula 18]

I_{MC[2, 1], 1}=k(V_{PR}−V_{W[2, 1]}+V_{X[2]}−Vₜₕ)² (18)

That is, when the potential V_{X[2]} is supplied to the wiring RW[2], the current flowing from the wiring BL[1] to the transistor Tr12 in the memory cell MC[2, 1] increases by ΔI_{MC[2, 1]}=I_{MC[2, 1], 1}−I_{MC[2, 1], 0}.

A current I_{MCref[2], 1} flowing from the wiring BLref to the transistor Tr12 in the memory cell MCref[2] in a period from Time T07 to Time T08 can be expressed by the following formula.

[Formula 19]

I_{MCref[2], 1}=k(V_{PR}+V_{X[2]}−Vₜₕ)² (19)

That is, when the potential V_{X[2]} is supplied to the wiring RW[2], the current flowing from the wiring BLref to the transistor Tr12 in the memory cell MCref[2] increases by ΔI_{MCref[2]}=I_{MCref[2], 1}−I_{MCref[2], 0}.

Furthermore, currents flowing through the wiring BL[1] and the wiring BLref are considered. The current I_{Cref} is supplied from the current source circuit CS to the wiring BLref. The current flowing through the wiring BLref is discharged to the current mirror circuit CM and the memory cells MCref[1] and MCref[2]. The following formula holds where I_{CM, 2} is the current discharged from the wiring BLref to the current mirror circuit CM.

[Formula 20]

I_{Cref}−I_{CM, 2}=I_{MCref[1], 1}+I_{MCref[2], 1} (20)

The current I_{C} from the current source circuit CS is supplied to the wiring BL[1]. The current flowing through the wiring BL[1] is discharged to the current mirror circuit CM and the memory cells MC[1, 1] and MC[2, 1]. Furthermore, the current flows from the wiring BL[1] to the offset circuit OFST. The following formula holds where I_{α, 2} is the current flowing from the wiring BL[1] to the offset circuit OFST.

[Formula 21]

I_{C}−I_{CM, 2}=I_{MC[1, 1], 1}+I_{MC[2, 1], 1}+I_{α, 2} (21)

In addition, from the formulae (7) to (14) and the formulae (18) to (21), a difference between the current I_{α, 0} and the current I_{α, 2} (differential current ΔI_{α}) can be expressed by the following formula.

[Formula 22]

ΔI_{α}=I_{α, 2}−I_{α, 0}=2k(V_{W[1, 1]}V_{X[1]}+V_{W[2, 1]}V_{X[2]} (22)

Thus, the differential current ΔI_{α} is a value corresponding to the sum of the product of the potential V_{W[1, 1]} and the potential V_{X[1]} and the product of the potential V_{W[2, 1]} and the potential V_{X[2]}.

After that, in a period from Time T08 to Time T09, the potentials of the wirings RW[1] and RW[2] become the reference potential, and the potentials of the nodes NM[1, 1] and NM[2, 1] and the nodes NMref[1] and NMref[2] become similar to those in a period from Time T04 to Time T05.

As represented by the formula (17) and the formula (22), the differential current ΔI_{α} input to the offset circuit OFST can be calculated from the formula including a product term of the potentials V_{W} corresponding to the first data (weight) and the potential V_{X} corresponding to the second data (input data). In other words, measurement of the differential current ΔI_{α} with the offset circuit OFST gives the result of the product-sum operation of the first data and the second data.

Note that although the memory cells MC[1, 1] and MC[2, 1] and the memory cells MCref[1] and MCref[2] are particularly focused on in the above description, the number of the memory cells MC and the memory cells MCref can be freely set. In the case where the number m of rows of the memory cells MC and the memory cells MCref is an arbitrary number i, the differential current ΔI_{α} can be expressed by the following formula.

[Formula 23]

ΔI_{α}=2kΣᵢⱼV_{W[i, 1]}V_{X[i]} (23)

When the number n of columns of the memory cells MC and the memory cells MCref is increased, the number of product-sum operations executed in parallel can be increased.

The product-sum operation of the first data and the second data can be performed using the semiconductor device MAC as described above. Note that the use of the configuration of the memory cells MC and the memory cells MCref in FIG. 13 allows the product-sum operation circuit to be formed of fewer transistors. Accordingly, the circuit scale of the semiconductor device MAC can be reduced.

In the case where the semiconductor device MAC is used for the operation in the neural network, the number m of rows of the memory cells MC can correspond to the number of pieces of input data supplied to one neuron and the number n of columns of the memory cells MC can correspond to the number of neurons.

Note that there is no particular limitation on the structure of the neural network for which the semiconductor device MAC is used. For example, the semiconductor device MAC can also be used for a convolutional neural network (CNN), a recurrent neural network (RNN), an autoencoder, a Boltzmann machine (including a restricted Boltzmann machine), or the like.

The product-sum operation in the neural network can be performed using the semiconductor device MAC as described above. Furthermore, the memory cells MC and the memory cells MCref illustrated in FIG. 13 are used for the cell array CA, whereby an integrated circuit with improved operation accuracy, lower power consumption, or a reduced circuit scale can be provided.

This embodiment can be combined with the description of the other embodiments as appropriate.

### Embodiment 3

In this embodiment, a display panel that can be used in a semiconductor device which operates by an image processing method of one embodiment of the present invention will be described.

### <Structure Example of Pixel>

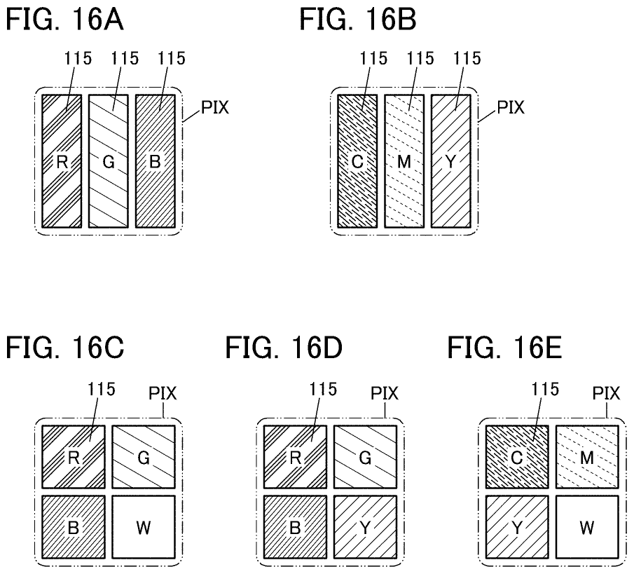

First, structure examples of the pixel PIX are described with reference to FIGS. 16(A) to 16(E).

The pixel PIX includes a plurality of pixels 115. The plurality of pixels 115 each function as a subpixel. The pixel PIX is formed of the plurality of pixels 115 exhibiting different colors, and thus full-color display can be achieved in a display portion.

The pixels PIX illustrated in FIGS. 16(A) and 16(B) each include three subpixels. The combination of the pixels 115 included in the pixel PIX illustrated in FIG. 16(A) is red (R), green (G), and blue (B). The combination of the pixels 115 included in the pixel PIX illustrated in FIG. 16(B) is cyan (C), magenta (M), and yellow (Y).

The pixels PIX illustrated in FIGS. 16(C) to 16(E) each include four subpixels. The combination of the pixels 115 included in the pixel PIX illustrated in FIG. 16(C) is red (R), green (G), blue (B), and white (W). The use of the subpixel that exhibits white can increase the luminance of the display region. The combination of the pixels 115 included in the pixel PIX illustrated in FIG. 16(D) is red (R), green (G), blue (B), and yellow (Y). The combination of the pixels 115 included in the pixel PIX illustrated in FIG. 16(E) is cyan (C), magenta (M), yellow (Y), and white (W).

When subpixels that exhibit red, green, blue, cyan, magenta, yellow, and the like are combined as appropriate with more subpixels functioning as one pixel, the reproducibility of halftones can be increased. Thus, the display quality can be improved.

The display device of one embodiment of the present invention can reproduce the color gamut of various standards. For example, the display device of one embodiment of the present invention can reproduce the color gamut of the following standards: the PAL (Phase Alternating Line) or NTSC (National Television System Committee) standard used for TV broadcasting; the sRGB (standard RGB) or Adobe RGB standard used widely for display devices in electronic devices such as personal computers, digital cameras, and printers; the ITU-R BT709 (International Telecommunication Union Radiocommunication Sector Broadcasting Service (Television) 709) standard used for HDTV (High Definition Televisions, also referred to Hi-Vision); the DCI-P3 (Digital Cinema Initiatives P3) standard used for digital cinema projection; and the ITU-R BT.2020 (REC.2020 (Recommendation 2020)) standard used for UHDTV (Ultra High Definition Television, also referred to as Super Hi-Vision); and the like.

Using the pixels PIX arranged in a 1920×1080 matrix, the display device can display a full-color image with 2K resolution. Moreover, for example, using the pixels PIX arranged in a 3840×2160 matrix, the display device can display a full-color image with 4K resolution. Furthermore, for example, using the pixels PIX arranged in a 7680×4320 matrix, the display device can display a full-color image with 8K resolution. Using a larger number of the pixels PIX, the display device can display a full-color image with 16K or 32K resolution.

### <Configuration Example of Pixel Circuit>

Examples of a display element included in the display device of one embodiment of the present invention include a light-emitting element such as an inorganic EL element, an organic EL element, or an LED, a liquid crystal element, an electrophoretic element, and a display element using micro electro mechanical systems (MEMS).

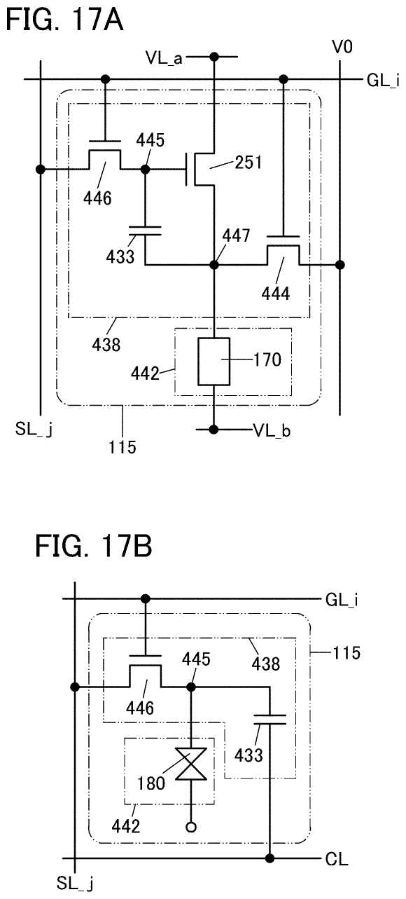

A configuration example of a pixel circuit including a light-emitting element is described below with reference to FIG. 17(A). In addition, a configuration example of a pixel circuit including a liquid crystal element is described with reference to FIG. 17(B).

A pixel circuit 438 illustrated in FIG. 17(A) includes a transistor 446, a capacitor 433, a transistor 251, and a transistor 444. The pixel circuit 438 is electrically connected to a light-emitting element 170 that functions as a display element 442.

One of a source electrode and a drain electrode of the transistor 446 is electrically connected to the signal line SL_j to which an image signal is supplied. A gate electrode of the transistor 446 is electrically connected to the scan line GL_i to which a selection signal is supplied.

The transistor 446 has a function of controlling whether to write an image signal to a node 445.

One of a pair of electrodes of the capacitor 433 is electrically connected to the node 445, and the other is electrically connected to a node 447. The other of the source electrode and the drain electrode of the transistor 446 is electrically connected to the node 445.

The capacitor 433 functions as a storage capacitor for storing data written to the node 445.

One of a source electrode and a drain electrode of the transistor 251 is electrically connected to a potential supply line VL_a, and the other is electrically connected to the node 447. Furthermore, a gate electrode of the transistor 251 is electrically connected to the node 445.

One of a source electrode and a drain electrode of the transistor 444 is electrically connected to a potential supply line V0, and the other is electrically connected to the node 447. Furthermore, a gate electrode of the transistor 444 is electrically connected to the scan line GL_i.

One of an anode and a cathode of the light-emitting element 170 is electrically connected to a potential supply line VL_b, and the other is electrically connected to the node 447.

As a power supply potential, a potential on the relatively high potential side or a potential on the relatively low potential side can be used, for example. A power supply potential on the high potential side is referred to as a high power supply potential (also referred to as “VDD”), and a power supply potential on the low potential side is referred to as a low power supply potential (also referred to as “VSS”). A ground potential can be used as the high power supply potential or the low power supply potential. For example, in the case where a ground potential is used as the high power supply potential, the low power supply potential is a potential lower than the ground potential, and in the case where a ground potential is used as the low power supply potential, the high power supply potential is a potential higher than the ground potential.

A high power supply potential VDD is supplied to one of the potential supply line VL_a and the potential supply line VL_b, and a low power supply potential VSS is supplied to the other, for example.

In the display device including the pixel circuit 438 in FIG. 17(A), the pixel circuits 438 are sequentially selected row by row by the scan line driver circuit, whereby the transistors 446 and the transistors 444 are turned on and an image signal is written to the nodes 445.

When the transistors 446 and the transistors 444 are turned off, the pixel circuits 438 in which the data has been written to the nodes 445 are brought into a holding state. Furthermore, the amount of current flowing between the source electrode and the drain electrode of the transistor 251 is controlled in accordance with the potential of the data written to the node 445. The light-emitting element 170 emits light with a luminance corresponding to the amount of current flow. This operation is sequentially performed row by row; thus, an image can be displayed.

The pixel circuit 438 in FIG. 17(B) includes the transistor 446 and the capacitor 433. The pixel circuit 438 is electrically connected to a liquid crystal element 180 functioning as the display element 442.

The potential of one of a pair of electrodes of the liquid crystal element 180 is set in accordance with the specifications of the pixel circuit 438 as appropriate. The alignment state of the liquid crystal element 180 is set depending on the data written to the node 445. Note that a common potential may be supplied to one of the pair of electrodes of the liquid crystal element 180 included in each of the plurality of pixel circuits 438. Alternatively, the potential supplied to one of the pair of electrodes of the liquid crystal element 180 connected to the pixel circuit 438 may differ depending on the row.

In the pixel circuit 438 in the i-th row and the j-th column, one of the source electrode and the drain electrode of the transistor 446 is electrically connected to the signal line SL_j, and the other is electrically connected to the node 445. The gate electrode of the transistor 446 is electrically connected to the scan line GL_i. The transistor 446 has a function of controlling whether to write an image signal to the node 445.

One of the pair of electrodes of the capacitor 433 is electrically connected to a wiring to which a specific potential is supplied (hereinafter, referred to as a capacitor line CL), and the other is electrically connected to the node 445. The other of the pair of electrodes of the liquid crystal element 180 is electrically connected to the node 445. The potential of the capacitor line CL is set in accordance with the specifications of the pixel circuit 438 as appropriate. The capacitor 433 functions as a storage capacitor for storing data written to the node 445.

In the display device including the pixel circuit 438 in FIG. 17(B), the pixel circuits 438 are sequentially selected row by row by the scan line driver circuit, whereby the transistors 446 are turned on and an image signal is written to the nodes 445.

When the transistors 446 are turned off, the pixel circuits 438 in which the image signal has been written to the nodes 445 are brought into a holding state. This operation is sequentially performed row by row; thus, an image can be displayed on a display region 235.

### <Structure Example of Display Device>

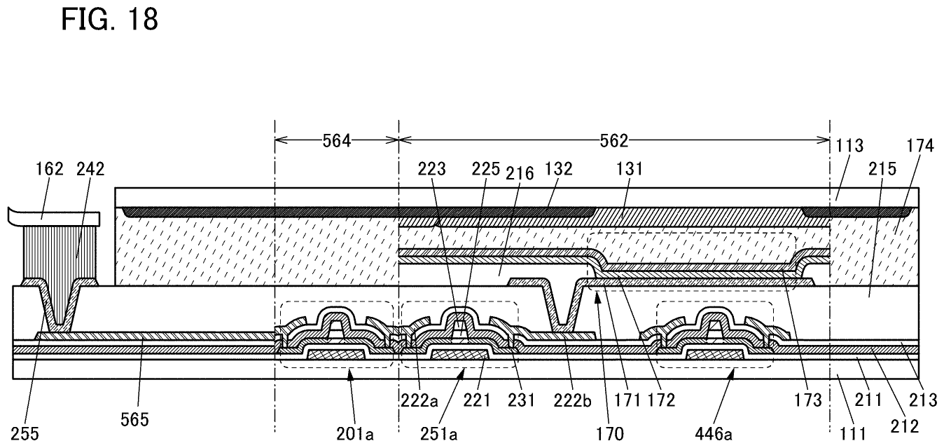

Next, structure examples of the display device are described with reference to FIG. 18 to FIG. 21.

FIG. 18 is a cross-sectional view of a light-emitting display device employing a color filter method and having a top-emission structure.

The display device illustrated in FIG. 18 includes a display portion 562 and a scan line driver circuit 564.

A transistor 251a, a transistor 446a, the light-emitting element 170, and the like are provided over the substrate 111 in the display portion 562. A transistor 201a and the like are provided over the substrate 111 in the scan line driver circuit 564.

The transistor 251a includes a conductive layer 221 functioning as a first gate electrode, an insulating layer 211 functioning as a first gate insulating layer, a semiconductor layer 231, a conductive layer 222a and a conductive layer 222b functioning as a source electrode and a drain electrode, a conductive layer 223 functioning as a second gate electrode, and an insulating layer 225 functioning as a second gate insulating layer. The semiconductor layer 231 includes a channel formation region and a low-resistance region. The channel formation region overlaps with the conductive layer 223 with the insulating layer 225 positioned therebetween. The low-resistance region includes a region connected to the conductive layer 222a and a region connected to the conductive layer 222b.

The transistor 251a includes the gates above and below the channel. It is preferable that the two gates be electrically connected to each other. A transistor with two gates that are electrically connected to each other can have a higher field-effect mobility and thus have higher on-state current than other transistors. Consequently, a circuit capable of high-speed operation can be obtained. Furthermore, the area occupied by a circuit portion can be reduced. The use of the transistor having a high on-state current can reduce signal delay in wirings and can suppress display unevenness even in a display device in which the number of wirings is increased because of an increase in size or resolution. In addition, the area occupied by a circuit portion can be reduced, whereby the bezel of the display device can be narrowed. Moreover, with such a structure, a highly reliable transistor can be formed.

An insulating layer 212 and an insulating layer 213 are provided over the conductive layer 223, and the conductive layer 222a and the conductive layer 222b are provided thereover. In the structure of the transistor 251a, the conductive layer 221 can be physically distanced from the conductive layer 222a or 222b easily; thus, the parasitic capacitance therebetween can be reduced.

There is no particular limitation on the structure of the transistor in the display device. For example, a planar transistor, a staggered transistor, or an inverted staggered transistor may be used. A top-gate transistor structure or a bottom-gate transistor structure may be used. Gate electrodes may be provided above and below a channel.

The transistor 251a includes a metal oxide in the semiconductor layer 231. The metal oxide can serve as an oxide semiconductor.

The transistor 446a and the transistor 201a have a structure similar to that of the transistor 251a. Structures of these transistors may be different in one embodiment of the present invention. A transistor included in the scan line driver circuit 564 and a transistor included in the display portion 562 may have the same structure or different structures. The transistors included in the scan line driver circuit 564 may have the same structure or the combination of two or more kinds of structures. Similarly, the transistors included in the display portion 562 may have the same structure or the combination of two or more kinds of structures.

The transistor 446a and the light-emitting element 170 overlap with each other with an insulating layer 215 positioned therebetween. A transistor, a capacitor, a wiring, and the like are provided to overlap with a light-emitting region of the light-emitting element 170, whereby an aperture ratio of the display portion 562 can be increased.

The light-emitting element 170 includes a pixel electrode 171, an EL layer 172, and a common electrode 173. The light-emitting element 170 emits light to the coloring layer 131 side.

One of the pixel electrode 171 and the common electrode 173 functions as an anode and the other functions as a cathode. When a voltage higher than the threshold voltage of the light-emitting element 170 is applied between the pixel electrode 171 and the common electrode 173, holes are injected to the EL layer 172 from the anode side and electrons are injected to the EL layer 172 from the cathode side. The injected electrons and holes are recombined in the EL layer 172 and a light-emitting substance contained in the EL layer 172 emits light.

The pixel electrode 171 is electrically connected to the conductive layer 222b of the transistor 251a. They may be directly connected to each other or may be connected via another conductive layer. The pixel electrode 171 functions as a pixel electrode and is provided for each light-emitting element 170. Two adjacent pixel electrodes 171 are electrically insulated from each other by an insulating layer 216.

The EL layer 172 is a layer containing a light-emitting substance.

The common electrode 173 functions as a common electrode and is shared by the plurality of light-emitting elements 170. A fixed potential is supplied to the common electrode 173.

The light-emitting element 170 and the coloring layer 131 overlap with each other with a bonding layer 174 positioned therebetween. The insulating layer 216 and a light-blocking layer 132 overlap with each other with the bonding layer 174 positioned therebetween.

The light-emitting element 170 may have a microcavity structure. Owing to the combination of a color filter (the coloring layer 131) and the microcavity structure, light with high color purity can be extracted from the display device.

The coloring layer 131 is a colored layer that transmits light in a specific wavelength range. For example, a color filter for transmitting light in a red, green, blue, or yellow wavelength range can be used. Examples of a material that can be used for the coloring layer 131 include a metal material, a resin material, and a resin material containing pigment or dye.

Note that one embodiment of the present invention is not limited to a color filter method, and a separate coloring method, a color conversion method, a quantum dot method, or the like may be employed.

The light-blocking layer 132 is provided between adjacent coloring layers 131. The light-blocking layer 132 blocks light emitted from an adjacent light-emitting element 170 to prevent color mixture between adjacent light-emitting elements 170. Here, the coloring layer 131 is provided such that its end portion overlaps with the light-blocking layer 132, whereby light leakage can be suppressed. For the light-blocking layer 132, a material that blocks light from the light-emitting element 170 can be used; for example, a black matrix can be formed using a metal material or a resin material containing pigment or dye. Note that it is preferable to provide the light-blocking layer 132 in a region other than the display portion 562, such as the scan line driver circuit 564, in which case undesired leakage of guided light or the like can be inhibited.

The substrate 111 and the substrate 113 are attached to each other with the bonding layer 174.

The conductive layer 565 is electrically connected to the FPC 162 through a conductive layer 255 and a connector 242. The conductive layer 565 is preferably formed using the same material and the same fabrication step as the conductive layers included in the transistor. In an example described in this embodiment, the conductive layer 565 is formed using the same material and the same fabrication step as the conductive layers functioning as a source and a drain.

As the connector 242, any of various anisotropic conductive films (ACF), anisotropic conductive pastes (ACP), and the like can be used.

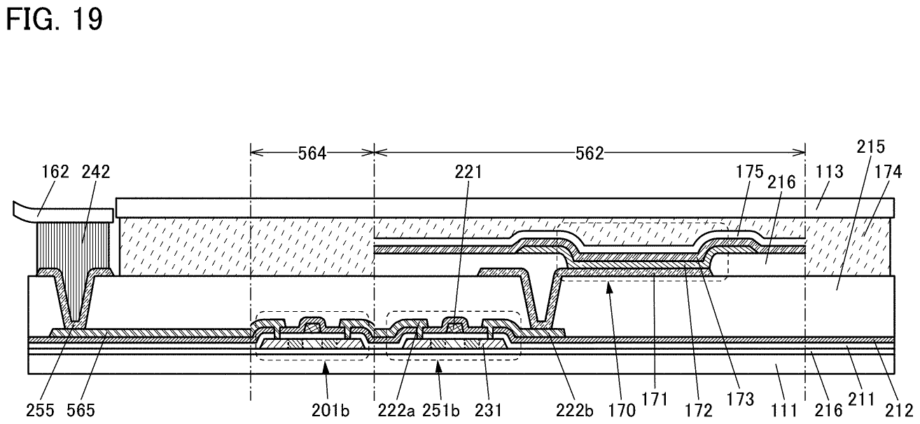

FIG. 19 is a cross-sectional view of a light-emitting display device employing a separate coloring method and having a bottom-emission structure.

The display device illustrated in FIG. 19 includes the display portion 562 and the scan line driver circuit 564.

A transistor 251b, the light-emitting element 170, and the like are provided over the substrate 111 in the display portion 562. A transistor 201b and the like are provided over the substrate 111 in the scan line driver circuit 564.

The transistor 251b includes the conductive layer 221 functioning as a gate electrode, the insulating layer 211 functioning as a gate insulating layer, the semiconductor layer 231, and the conductive layer 222a and the conductive layer 222b functioning as a source electrode and a drain electrode. The insulating layer 216 functions as a base film.

The transistor 251b includes LTPS (Low Temperature Poly-Silicon) in the semiconductor layer 231.

The light-emitting element 170 includes the pixel electrode 171, the EL layer 172, and the common electrode 173. The light-emitting element 170 emits light to the substrate 111 side. The pixel electrode 171 is electrically connected to the conductive layer 222b of the transistor 251b through an opening formed in the insulating layer 215. The EL layer 172 is provided in every light-emitting element 170 in a separated manner. The common electrode 173 is shared by the plurality of light-emitting elements 170.

The light-emitting element 170 is sealed with an insulating layer 175. The insulating layer 175 functions as a protective layer that prevents diffusion of impurities such as water into the light-emitting element 170.

The substrate 111 and the substrate 113 are attached to each other with the bonding layer 174.

The conductive layer 565 is electrically connected to the FPC 162 through the conductive layer 255 and the connector 242.

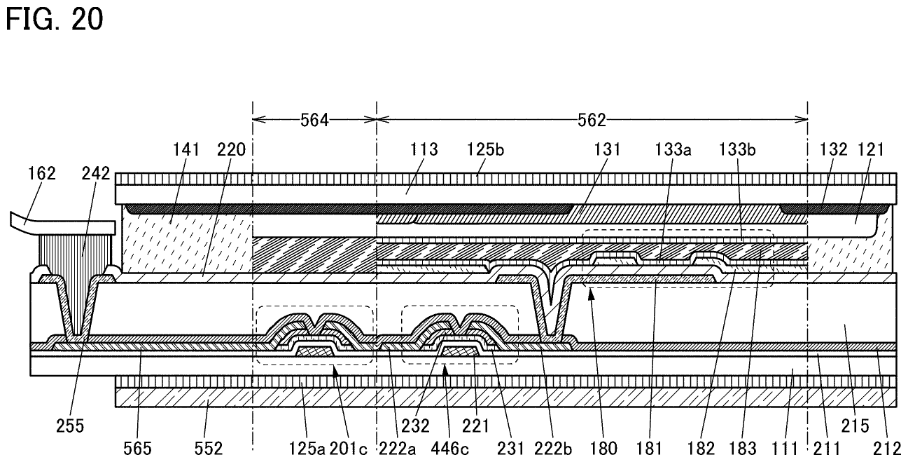

FIG. 20 is a cross-sectional view of a transmissive liquid crystal display device having a horizontal electric field mode.

The display device illustrated in FIG. 20 includes the display portion 562 and the scan line driver circuit 564.

A transistor 446c, the liquid crystal element 180, and the like are provided over the substrate 111 in the display portion 562. A transistor 201c and the like are provided over the substrate 111 in the scan line driver circuit 564.

The transistor 446c includes the conductive layer 221 functioning as a gate electrode, the insulating layer 211 functioning as a gate insulating layer, the semiconductor layer 231, an impurity semiconductor layer 232, and the conductive layer 222a and the conductive layer 222b functioning as a source electrode and a drain electrode. The transistor 446c is covered with the insulating layer 212.

The transistor 446c includes amorphous silicon in the semiconductor layer 231.

The liquid crystal element 180 is a liquid crystal element having an FFS (Fringe Field Switching) mode. The liquid crystal element 180 includes a pixel electrode 181, a common electrode 182, and a liquid crystal layer 183. The alignment of the liquid crystal layer 183 can be controlled with the electrical field generated between the pixel electrode 181 and the common electrode 182. The liquid crystal layer 183 is positioned between alignment films 133a and 133b. The pixel electrode 181 is electrically connected to the conductive layer 222b of the transistor 446c through an opening formed in the insulating layer 215. The common electrode 182 may have a top-surface shape (also referred to as a planar shape) that has a comb-like shape or a top-surface shape that is provided with a slit. One or more openings can be provided in the common electrode 182.

An insulating layer 220 is provided between the pixel electrode 181 and the common electrode 182. The pixel electrode 181 includes a portion that overlaps with the common electrode 182 with the insulating layer 220 positioned therebetween. Furthermore, an area where the common electrode 182 is not placed above the pixel electrode 181 exist in a region where the pixel electrode 181 and the coloring layer 131 overlap with each other.

An alignment film is preferably provided in contact with the liquid crystal layer 183. The alignment film can control the alignment of the liquid crystal layer 183.

Light from a backlight unit 552 is emitted to the outside of the display device through the substrate 111, the pixel electrode 181, the common electrode 182, the liquid crystal layer 183, the coloring layer 131, and the substrate 113. As materials of these layers that transmit the light from the backlight unit 552, visible-light-transmitting materials are used.

An overcoat 121 is preferably provided between the coloring layer 131 or the light-blocking layer 132, and the liquid crystal layer 183. The overcoat 121 can reduce the diffusion of impurities contained in the coloring layer 131, the light-blocking layer 132, and the like into the liquid crystal layer 183.

The substrate 111 and the substrate 113 are attached to each other with a bonding layer 141. The liquid crystal layer 183 is encapsulated in a region that is surrounded by the substrate 111, the substrate 113, and the bonding layer 141.

A polarizing plate 125a and a polarizing plate 125b are provided with the display portion 562 of the display device positioned therebetween. Light from the backlight unit 552 provided outside the polarizing plate 125a enters the display device through the polarizing plate 125a. In this case, the optical modulation of the light can be controlled by controlling the alignment of the liquid crystal layer 183 with a voltage supplied between the pixel electrode 181 and the common electrode 182. In other words, the intensity of light emitted through the polarizing plate 125b can be controlled. Furthermore, the coloring layer 131 absorbs light of wavelengths other than a specific wavelength range from the incident light. As a result, the ejected light is light that exhibits red, blue, or green colors, for example.

The conductive layer 565 is electrically connected to the FPC 162 through the conductive layer 255 and the connector 242.

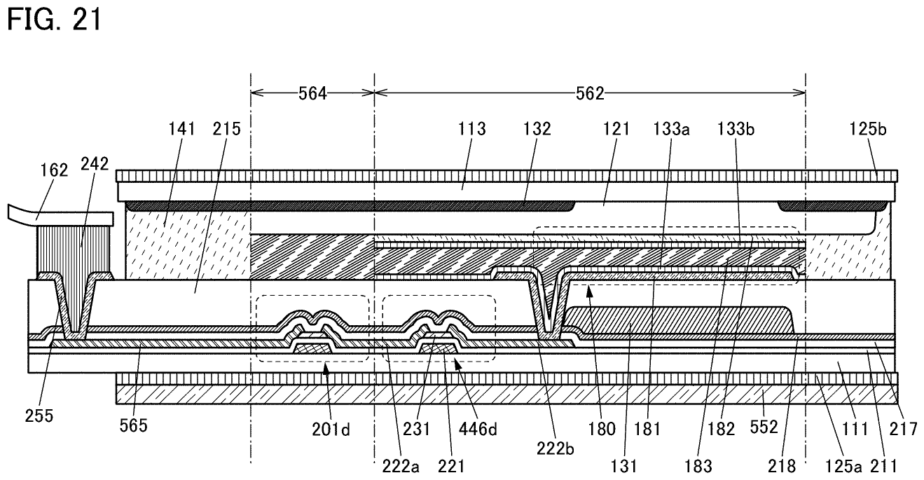

FIG. 21 is a cross-sectional view of a transmissive liquid crystal display device having a vertical electric field mode.

The display device illustrated in FIG. 21 includes the display portion 562 and the scan line driver circuit 564.

A transistor 446d, the liquid crystal element 180, and the like are provided over the substrate 111 in the display portion 562. A transistor 201d and the like are provided over the substrate 111 in the scan line driver circuit 564. The coloring layer 131 is provided on the substrate 111 side in the display device illustrated in FIG. 21. In this manner, the structure on the substrate 113 side can be simplified.

The transistor 446d includes the conductive layer 221 functioning as a gate electrode, the insulating layer 211 functioning as a gate insulating layer, the semiconductor layer 231, and the conductive layer 222a and the conductive layer 222b functioning as a source electrode and a drain electrode. The transistor 446d is covered with insulating layers 217 and 218.

The transistor 446d includes a metal oxide in the semiconductor layer 231.

The liquid crystal element 180 includes the pixel electrode 181, the common electrode 182, and the liquid crystal layer 183. The liquid crystal layer 183 is positioned between the pixel electrode 181 and the common electrode 182. The alignment film 133a is provided in contact with the pixel electrode 181. The alignment film 133b is provided in contact with and the common electrode 182. The pixel electrode 181 is electrically connected to the conductive layer 222b of the transistor 446d through an opening formed in the insulating layer 215.

Light from the backlight unit 552 is emitted to the outside of the display device through the substrate 111, the coloring layer 131, the pixel electrode 181, the liquid crystal layer 183, the common electrode 182, and the substrate 113. As materials of these layers that transmit the light from the backlight unit 552, visible-light-transmitting materials are used.

The overcoat 121 is provided between the light-blocking layer 132 and the common electrode 182.

The substrate 111 and the substrate 113 are attached to each other with the bonding layer 141. The liquid crystal layer 183 is encapsulated in a region that is surrounded by the substrate 11l, the substrate 113, and the bonding layer 141.

The polarizing plate 125a and the polarizing plate 125b are provided with the display portion 562 of the display device positioned therebetween.

The conductive layer 565 is electrically connected to the FPC 162 through the conductive layer 255 and the connector 242.

### <Structure Example of Transistor>

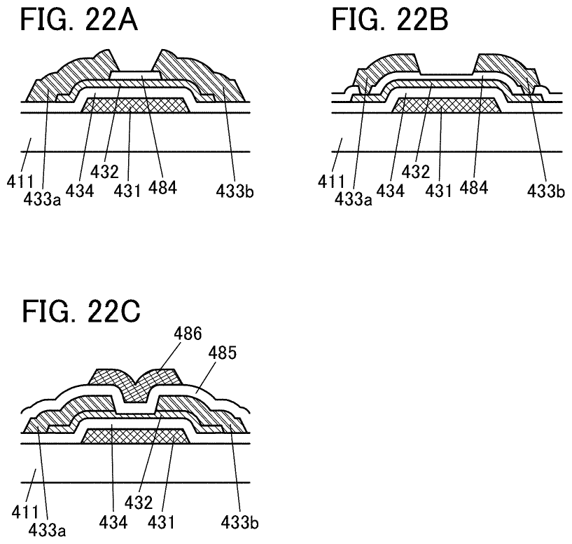

Next, structure examples of transistors having different structures from those illustrated in FIG. 18 to FIG. 21 are described with reference to FIG. 22 to FIG. 24.

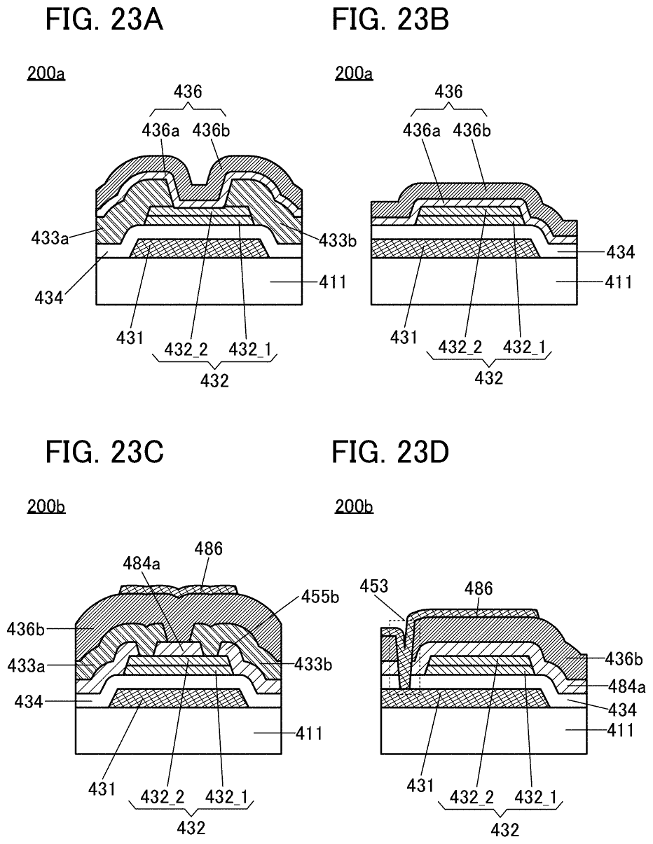

FIGS. 22(A) to 22(C) and FIGS. 23(A) to 23(D) illustrate transistors each including a metal oxide in a semiconductor layer 432. Since the semiconductor layer 432 includes a metal oxide, the frequency of updating an image signal can be set extremely low in a period when there is no change in an image or when the change is below a certain level, leading to reduced power consumption.

The transistors are each provided over an insulating surface 411. The transistors each include a conductive layer 431 functioning as a gate electrode, an insulating layer 434 functioning as a gate insulating layer, the semiconductor layer 432, and a pair of conductive layers 433a and 433b functioning as a source electrode and a drain electrode. A portion of the semiconductor layer 432 overlapping with the conductive layer 431 functions as a channel formation region. The semiconductor layer 432 and the conductive layer 433a or 433b are provided so as to be in contact with each other.

The transistor illustrated in FIG. 22(A) includes an insulating layer 484 over a channel formation region of the semiconductor layer 432. The insulating layer 484 serves as an etching stopper in the etching of the conductive layers 433a and 433b.

The transistor illustrated in FIG. 22(B) has a structure in which the insulating layer 484 extends over the insulating layer 434 to cover the semiconductor layer 432. In this structure, the conductive layers 433a and 433b are connected to the semiconductor layer 432 through openings formed in the insulating layer 484.

The transistor illustrated in FIG. 22(C) includes an insulating layer 485 and a conductive layer 486. The insulating layer 485 is provided to cover the semiconductor layer 432, the conductive layer 433a, and the conductive layer 433b. The conductive layer 486 is provided over the insulating layer 485 and includes a region overlapping with the semiconductor layer 432.

The conductive layer 486 is positioned on the side opposite from the conductive layer 431 with the semiconductor layer 432 positioned therebetween. In the case where the conductive layer 431 is used as a first gate electrode, the conductive layer 486 can serve as a second gate electrode. By supplying the same potential to the conductive layer 431 and the conductive layer 486, the on-state current of the transistor can be increased. When a potential for controlling the threshold voltage is supplied to one of the conductive layers 431 and 486 and a potential for driving is supplied to the other, the threshold voltage of the transistor can be controlled.

FIG. 23(A) is a cross-sectional view of a transistor 200a in the channel length direction, and FIG. 23(B) is a cross-sectional view of the transistor 200a in the channel width direction.

The transistor 200a is a modification example of the transistor 201d illustrated in FIG. 21.

The transistor 200a is different from the transistor 201d in the semiconductor layer 432.

The semiconductor layer 432 of the transistor 200a includes a semiconductor layer 432_1 over the insulating layer 434 and a semiconductor layer 432_2 over the semiconductor layer 432_1.

The semiconductor layer 432_1 and the semiconductor layer 432_2 preferably include the same element. The semiconductor layer 432_1 and the semiconductor layer 432_2 each preferably include In, M (M is Ga, Al, Y. or Sn), and Zn.

The semiconductor layer 432_1 and the semiconductor layer 4322 each preferably include a region where the atomic proportion of In is larger than the atomic proportion of M. For example, the atomic ratio of In to M and Zn in the semiconductor layer 432_1 and the semiconductor layer 432_2 is preferably InM:Zn=4:2:3 or in the neighborhood thereof. The term “neighborhood” includes the following: when In is 4, M is greater than or equal to 1.5 and less than or equal to 2.5, and Zn is greater than or equal to 2 and less than or equal to 4. Alternatively, the atomic ratio of In to M and Zn in the semiconductor layer 432_1 and the semiconductor layer 432_2 is preferably In:M:Zn=5:1:6 or in the neighborhood thereof. When the compositions of the semiconductor layer 432_1 and the semiconductor layer 432_2 are substantially the same, they can be formed using the same sputtering target and the manufacturing cost can thus be reduced. Since the same sputtering target is used, the semiconductor layer 432_1 and the semiconductor layer 432_2 can be formed successively in the same chamber in a vacuum. This can suppress entry of impurities into the interface between the semiconductor layer 432_1 and the semiconductor layer 432_2.

The semiconductor layer 432_1 may include a region having lower crystallinity than the semiconductor layer 432_2. Note that the crystallinity of the semiconductor layer 432_1 and the semiconductor layer 432_2 can be determined by analysis by X-ray diffraction (XRD) or with a transmission electron microscope (TEM).

The region having low crystallinity in the semiconductor layer 432_1 serves as a diffusion path of excess oxygen, through which excess oxygen can be diffused into the semiconductor layer 432_2 having higher crystallinity than the semiconductor layer 432_1. When a stacked-layer structure including the semiconductor layers having different crystal structures is employed and the region having low crystallinity is used as a diffusion path of excess oxygen as described above, the transistor can be highly reliable.

The semiconductor layer 432_2 having a region having higher crystallinity than the semiconductor layer 432_1 can prevent impurities from entering the semiconductor layer 432. In particular, the increased crystallinity of the semiconductor layer 432_2 can reduce damage at the time of forming the conductive layers 433a and 433b. The surface of the semiconductor layer 432, i.e., the surface of the semiconductor layer 432_2 is exposed to an etchant or an etching gas at the time of forming the conductive layers 433a and 433b by etching. However, when the semiconductor layer 432_2 has a region having high crystallinity, the semiconductor layer 432_2 has higher etching resistance than the semiconductor layer 432_1 having low crystallinity. Therefore, the semiconductor layer 432_2 serves as an etching stopper.

When the semiconductor layer 432_1 has a region having lower crystallinity than the semiconductor layer 432_2, the semiconductor layer 432_1 has a high carrier density in some cases.

When the semiconductor layer 432_1 has a high carrier density, the Fermi level is sometimes high relative to the conduction band of the semiconductor layer 432_1. This lowers the conduction band minimum of the semiconductor layer 432_1, so that the energy difference between the conduction band minimum of the semiconductor layer 432_1 and the trap level, which might be formed in a gate insulating layer (here, the insulating layer 434), is increased in some cases. The increase of the energy difference can reduce trap of charges in the gate insulating layer and reduce variation in the threshold voltage of the transistor, in some cases. In addition, when the semiconductor layer 432_1 has a high carrier density, the semiconductor layer 432 can have high field-effect mobility.

Although the semiconductor layer 432 in the transistor 200a has a stacked-layer structure of two layers in this example, the structure is not limited thereto, and the semiconductor layer 432 may have a stacked structure of three or more layers.

A structure of an insulating layer 436 provided over the conductive layer 433a and the conductive layer 433b is described.

The insulating layer 436 of the transistor 200a includes an insulating layer 436a and an insulating layer 436b over the insulating layer 436a. The insulating layer 436a has a function of supplying oxygen to the semiconductor layer 432 and function of preventing entry of impurities (typically, water, hydrogen, and the like). As the insulating layer 436a, an aluminum oxide film, an aluminum oxynitride film, or an aluminum nitride oxide film can be used. In particular, the insulating layer 436a is preferably an aluminum oxide film formed by a reactive sputtering method. As an example of a method for forming an aluminum oxide by a reactive sputtering method, the following method can be given.

First, a mixed gas of an inert gas (typically, an Ar gas) and an oxygen gas is introduced into a sputtering chamber. Subsequently, a voltage is applied to an aluminum target provided in the sputtering chamber, whereby the aluminum oxide film can be deposited. As a power source for applying a voltage to the aluminum target, a DC power source, an AC power source, or an RF power source can be given. The DC power source is particularly preferably used to improve the productivity.

The insulating layer 436b has a function of preventing the entry of impurities (typically, water, hydrogen, and the like). As the insulating layer 436b, a silicon nitride film, a silicon nitride oxide film, or a silicon oxynitride film can be used. In particular, a silicon nitride film formed by a PECVD method is preferably used as the insulating layer 436b. The silicon nitride film formed by a PECVD method is preferable because the film is likely to have a high film density. Note that the hydrogen concentration in the silicon nitride film formed by a PECVD method is high in some cases.

Since the insulating layer 436a is provided below the insulating layer 436b in the transistor 200a, hydrogen in the insulating layer 436b does not diffuse into the semiconductor layer 432 side or does not easily diffuse into the semiconductor layer 432 side.

The transistor 200a is a single-gate transistor. The use of a single-gate transistor can reduce the number of masks, leading to increased productivity.

FIG. 23(C) is a cross-sectional view of a transistor 200b in the channel length direction, and FIG. 23(D) is a cross-sectional view of the transistor 200b in the channel width direction.

The transistor 200b is a modification example of the transistor illustrated in FIG. 22(B).

The transistor 200b is different from the transistor illustrated in FIG. 22(B) in the structures of the semiconductor layer 432 and the insulating layer 484. Specifically, the transistor 200b includes the semiconductor layer 432 having a two-layer structure, and the transistor 200b includes an insulating layer 484a instead of the insulating layer 484. The transistor 200b further includes the insulating layer 436b and the conductive layer 486.

The insulating layer 484a has a function similar to that of the insulating layer 436a.

An opening 453 is provided through the insulating layers 434, 484a, and 436b. The conductive layer 486 is electrically connected to the conductive layer 431 in the opening 453.

The transistor 200a and the transistor 200b having the structures illustrated in FIG. 23 can be formed using the existing production line without high capital investment. For example, a manufacturing plant for an oxide semiconductor can be simply substituted for a manufacturing plant for hydrogenated amorphous silicon.

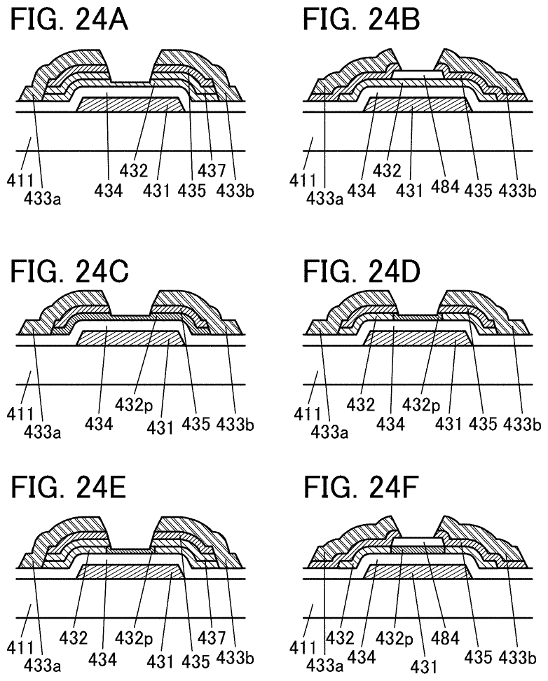

FIGS. 24(A) to 24(F) illustrate transistors including silicon in the semiconductor layer.

The transistors are each provided over the insulating surface 411. The transistors each include the conductive layer 431 functioning as a gate electrode, the insulating layer 434 functioning as a gate insulating layer, one or both of the semiconductor layer 432 and a semiconductor layer 432p, a pair of conductive layers 433a and 433b functioning as a source electrode and a drain electrode, and an impurity semiconductor layer 435. A region of the semiconductor layer overlapping with the conductive layer 431 functions as a channel formation region. The semiconductor layer is in contact with the conductive layer 433a or 433b.

The transistor illustrated in FIG. 24(A) is a transistor with a bottom-gate channel-etched structure. The impurity semiconductor layer 435 is provided between the semiconductor layer 432 and the conductive layers 433a and 433b.

The transistor illustrated in FIG. 24(A) includes a semiconductor layer 437 between the semiconductor layer 432 and the impurity semiconductor layer 435.

The semiconductor layer 437 may be formed using a semiconductor film similar to the semiconductor layer 432. The semiconductor layer 437 can serve as an etching stopper that prevents the removal of the semiconductor layer 432 in the etching of the impurity semiconductor layer 435. Although FIG. 24(A) illustrates an example in which the semiconductor layer 437 is divided into a right part and a left part, the semiconductor layer 437 may partly cover the channel formation region of the semiconductor layer 432.

The semiconductor layer 437 may include an impurity at a concentration lower than the impurity semiconductor layer 435. In that case, the semiconductor layer 437 can serve as an LDD (Lightly Doped Drain) regions, so that hot-carrier degradation that is caused when a transistor is driven can be suppressed.

The transistor illustrated in FIG. 24(B) includes the insulating layer 484 over the channel formation region of the semiconductor layer 432. The insulating layer 484 serves as an etching stopper in the etching of the impurity semiconductor layer 435.

The transistor illustrated in FIG. 24(C) includes the semiconductor layer 432p instead of the semiconductor layer 432. The semiconductor layer 432p includes a semiconductor film having high crystallinity. The semiconductor layer 432p includes a polycrystalline semiconductor or a single crystal semiconductor, for example. With such a structure, a transistor with high field-effect mobility can be formed.

The transistor illustrated in FIG. 24(D) includes the semiconductor layer 432p in the channel formation region of the semiconductor layer 432. The transistor illustrated in FIG. 24(D) can be formed by, for example, irradiation of a semiconductor film to be the semiconductor layer 432 with laser light or the like to locally crystallize the semiconductor film. In this way, a transistor having high field-effect mobility can be obtained.

The transistor illustrated in FIG. 24(E) includes the semiconductor layer 432p having crystallinity in the channel formation region of the semiconductor layer 432 illustrated in FIG. 24(A).

The transistor illustrated in FIG. 24(F) includes the semiconductor layer 432p having crystallinity in the channel formation region of the semiconductor layer 432 illustrated in FIG. 24(B).

### [Semiconductor Layer]

There is no particular limitation on the crystallinity of a semiconductor material used for the transistors disclosed in one embodiment of the present invention, and an amorphous semiconductor or a semiconductor having crystallinity (a microcrystalline semiconductor, a polycrystalline semiconductor, a single crystal semiconductor, or a semiconductor partly including crystal regions) may be used. A semiconductor having crystallinity is preferably used, in which case deterioration of the transistor characteristics can be suppressed.

As a semiconductor material used for the transistors, a metal oxide whose energy gap is greater than or equal to 2 eV, preferably greater than or equal to 2.5 eV, further preferably greater than or equal to 3 eV can be used. A typical example thereof is a metal oxide containing indium, and for example, a CAC-OS described later or the like can be used.

A transistor with a metal oxide having a larger band gap and a lower carrier density than silicon has a low off-state current; therefore, charges stored in a capacitor that is series-connected to the transistor can be held for a long time.

The semiconductor layer can be, for example, a film represented by an In-M-Zn-based oxide that contains indium, zinc, and M (a metal such as aluminum, titanium, gallium, germanium, yttrium, zirconium, lanthanum, cerium, tin, neodymium, or hafnium).

In the case where the metal oxide contained in the semiconductor layer contains an In-M-Zn-based oxide, it is preferable that the atomic ratio of metal elements of a sputtering target used for forming a film of the In-M-Zn oxide satisfy In≥M and Zn≥M. The atomic ratio of metal elements of such a sputtering target is preferably, for example, In:M:Zn=1:1:1, InM:Zn=1:1:1.2, InM:Zn=3:1:2, InM:Zn=4:2:3, InM:Zn=4:2:4.1, InM:Zn=5:1:6, InMZn=5:1:7, or In:M:Zn=5:1:8. Note that the atomic ratio of metal elements in the formed semiconductor layer varies from the above atomic ratios of metal elements of the sputtering targets in a range of ±40%.

As a semiconductor material used for the transistor, for example, silicon can be used. In particular, amorphous silicon is preferably used as the silicon. By using amorphous silicon, the transistor can be formed over a large-area substrate with high yield, so that mass productivity can be improved.

Alternatively, silicon having crystallinity such as microcrystalline silicon, polycrystalline silicon, or single crystal silicon can be used. In particular, polycrystalline silicon can be formed at a lower temperature than single-crystal silicon and has higher field-effect mobility and higher reliability than amorphous silicon.

This embodiment can be combined with the description of the other embodiments as appropriate.

### Embodiment 4

### <Composition of CAC-OS>

The composition of a CAC (Cloud-Aligned Composite)-OS which can be used for a transistor disclosed in one embodiment of the present invention will be described below.

The CAC-OS is, for example, a composition of a material in which elements included in an oxide semiconductor are unevenly distributed to have a size of greater than or equal to 0.5 nm and less than or equal to 10 nm, preferably greater than or equal to 1 nm and less than or equal to 2 nm, or a similar size. Note that in the following description, a state in which one or more metal elements are unevenly distributed and regions including the metal element(s) are mixed to have a size of greater than or equal to 0.5 nm and less than or equal to 10 nm, preferably greater than or equal to 1 nm and less than or equal to 2 nm, or a similar size in an oxide semiconductor is referred to as a mosaic pattern or a patch-like pattern.

Note that the oxide semiconductor preferably contains at least indium. In particular, indium and zinc are preferably contained. In addition, one or more elements selected from aluminum, gallium, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like may be contained.

For instance, a CAC-OS in an In—Ga—Zn oxide (an In—Ga—Zn oxide in the CAC-OS may be particularly referred to as CAC-IGZO) has a composition with a mosaic pattern in which materials are separated into indium oxide (InO_{X1}, where X1 is a real number greater than 0) or indium zinc oxide (In_{X2}Zn_{Y2}O_{Z2}, where X2, Y2, and Z2 are each a real number greater than 0) and gallium oxide (GaO_{X3}, where X3 is a real number greater than 0) or gallium zinc oxide (Ga_{X4}Zn_{Y4}O_{Z4}, where X4, Y4, and Z4 are each a real number greater than 0), for example, and InO_{X1} or In_{X2}Zn_{Y2}O_{Z2} forming the mosaic pattern is evenly distributed in the film (which is hereinafter also referred to as cloud-like).

That is, the CAC-OS is a composite oxide semiconductor with a composition in which a region including GaO_{X3} as a main component and a region including In_{X2}Zn_{Y2}O_{Z2} or InO_{X1} as a main component are mixed. Note that in this specification, for example, when the atomic ratio of In to an element M in a first region is larger than the atomic ratio of In to the element M in a second region, the first region is regarded as having a higher In concentration than the second region.

Note that IGZO is a commonly known name and sometimes refers to one compound formed of In, Ga, Zn, and O. A typical example is a crystalline compound represented by InGaO₃(ZnO)ₘ₁ (m1 is a natural number) or a crystalline compound represented by In₍₁₊ₓ₀₎Ga₍₁₋ₓ₀₎O₃(ZnO)ₘ₀ (−1≤x0≤1; m0 is a given number).

The above crystalline compound has a single crystal structure, a polycrystalline structure, or a CAAC (C Axis Aligned Crystalline) structure. Note that the CAAC structure is a crystal structure in which a plurality of IGZO nanocrystals have c-axis alignment and are connected in the a-b plane direction without alignment.

On the other hand, the CAC-OS relates to the material composition of an oxide semiconductor. The CAC-OS refers to a composition in which, in the material composition containing In, Ga, Zn, and O, some regions that include Ga as a main component and are observed as nanoparticles and some regions that include In as a main component and are observed as nanoparticles are randomly dispersed in a mosaic pattern. Therefore, the crystal structure is a secondary element for the CAC-OS.

Note that the CAC-OS does not include a stacked-layer structure of two or more kinds of films with different compositions. For example, a two-layer structure of a film including In as a main component and a film including Ga as a main component is not included.

A boundary between the region including GaO_{X3} as a main component and the region including In_{X2}Zn_{Y2}O_{Z2} or InO_{X1} as a main component is not clearly observed in some cases.

Note that in the case where one kind or a plurality of kinds selected from aluminum, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like are contained instead of gallium, the CAC-OS refers to a composition in which some regions that contain the metal element(s) as a main component and are observed as nanoparticles and some regions that contain In as a main component and are observed as nanoparticles are randomly dispersed in a mosaic pattern.

The CAC-OS can be formed by a sputtering method under conditions where a substrate is not heated intentionally, for example. In the case of forming the CAC-OS by a sputtering method, one or more gases selected from an inert gas (typically, argon), an oxygen gas, and a nitrogen gas may be used as a deposition gas. Furthermore, the ratio of the flow rate of an oxygen gas to the total flow rate of the deposition gas at the time of deposition is preferably as low as possible, and for example, the ratio of the flow rate of the oxygen gas is preferably higher than or equal to 0% and lower than 30%, further preferably higher than or equal to 0% and lower than or equal to 10%.

The CAC-OS is characterized in that no clear peak is observed in measurement using θ/2θ scan by an out-of-plane method, which is an X-ray diffraction (XRD) measurement method. That is, it is found from the X-ray diffraction that no alignment in the a-b plane direction and the c-axis direction is observed in a measured region.

In an electron diffraction pattern of the CAC-OS which is obtained by irradiation with an electron beam with a probe diameter of 1 nm (also referred to as a nanometer-sized electron beam), a ring-like region with high luminance and a plurality of bright spots in the ring region are observed. Therefore, the electron diffraction pattern indicates that the crystal structure of the CAC-OS includes an nc (nano-crystal) structure with no alignment in the plan-view direction and the cross-sectional direction.

For example, energy dispersive X-ray spectroscopy (EDX) is used to obtain EDX mapping, and according to the EDX mapping, the CAC-OS in the In—Ga—Zn oxide has a composition in which the regions including GaO_{X3} as a main component and the regions including In_{X2}Zn_{Y2}O_{Z2} or InO_{X1} as a main component are unevenly distributed and mixed.

The CAC-OS has a composition different from that of an IGZO compound in which the metal elements are evenly distributed, and has characteristics different from those of the IGZO compound. That is, the CAC-OS has a composition in which regions where GaO_{X3} or the like is a main component and regions where In_{X2}Zn_{Y2}O_{Z2} or InO_{X1} is a main component are phase-separated from each other and form a mosaic pattern.

Here, a region where In_{X2}Zn_{Y2}O_{Z2} or InO_{X1} is a main component is a region whose conductivity is higher than that of a region where GaO_{X3} or the like is a main component. In other words, when carriers flow through the regions where In_{X2}Zn_{Y2}O_{Z2} or InO_{X1} is a main component, the conductivity of an oxide semiconductor is exhibited. Accordingly, when regions including In_{X2}Zn_{T2}O_{Z2} or InO_{X1} as a main component are distributed in an oxide semiconductor like a cloud, high field-effect mobility (μ) can be achieved.

In contrast, a region where GaO_{X3} or the like is a main component is a region whose insulating property is higher than that of a region where In_{X2}Zn_{Y2}O_{Z2} or InO_{X1} is a main component. In other words, when regions where GaO_{X3} or the like is a main component are distributed in an oxide semiconductor, leakage current can be suppressed and favorable switching operation can be achieved.

Accordingly, when a CAC-OS is used for a semiconductor element, the insulating property derived from GaO_{X3} or the like and the conductivity derived from In_{X2}Zn_{Y2}O_{Z2} or InO_{X1} complement each other, whereby high on-state current (Ion) and high field-effect mobility (μ) can be achieved.

A semiconductor element including a CAC-OS has high reliability. Thus, the CAC-OS is suitably used in a variety of semiconductor devices typified by a display.

This embodiment can be combined with the description of the other embodiments as appropriate.

### Embodiment 5

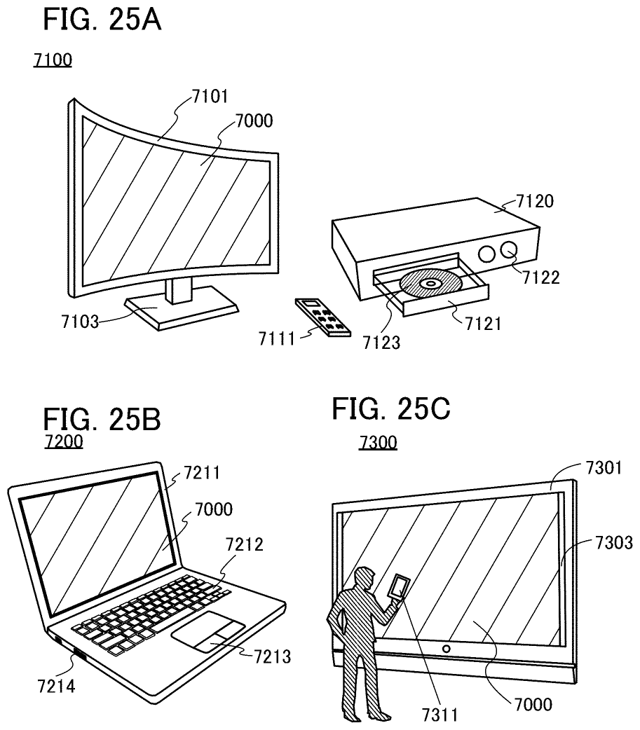

In this embodiment, an electronic device of one embodiment of the present invention will be described with reference to FIG. 25.

Electronic devices of this embodiment include a semiconductor device that operates by an image processing method of one embodiment of the present invention. Therefore, a display portion of the electronic devices can display a high-quality image.

The display portion of the electronic device of this embodiment can display, for example, an image with a resolution of full high definition, 2K, 4K, 8K, 16K, or more. As a screen size of the display portion, the diagonal size can be greater than or equal to 20 inches, greater than or equal to 30 inches, greater than or equal to 50 inches, greater than or equal to 60 inches, or greater than or equal to 70 inches.

Examples of electronic devices include electronic devices with a relatively large screen, such as a television device, a desktop or laptop personal computer, a monitor of a computer or the like, digital signage, and a large game machine (e.g., a pachinko machine); a digital camera; a digital video camera; a digital photo frame; a mobile phone; a portable game console; a portable information terminal; and an audio reproducing device.

The electronic device of one embodiment of the present invention may include an antenna. When a signal is received by the antenna, the electronic device can display an image, data, or the like on a display portion. When the electronic device includes the antenna and a secondary battery, the antenna may be used for contactless power transmission.

The electronic device of one embodiment of the present invention may include a sensor (a sensor having a function of measuring force, displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays).

The electronic device of one embodiment of the present invention can have a variety of functions such as a function of displaying a variety of information (e.g., a still image, a moving image, and a text image) on the display portion, a touch panel function, a function of displaying a calendar, date, time, and the like, a function of executing a variety of software (programs), a wireless communication function, and a function of reading out a program or data stored in a recording medium.

FIG. 25(A) illustrates an example of a television device. In a television device 7100, a display portion 7000 is incorporated in a housing 7101. Here, the housing 7101 is supported by a stand 7103.

When the semiconductor device which operates by an image processing method of one embodiment of the present invention is used in the television device 7100, the display portion 7000 can display a high-quality image.

The television device 7100 illustrated in FIG. 25(A) can be operated with an operation switch provided in the housing 7101 or a separate remote controller 7111. Furthermore, the display portion 7000 may include a touch sensor. The television device 7100 can be operated by touching the display portion 7000 with a finger or the like. Furthermore, the remote controller 7111 may be provided with a display portion for displaying data output from the remote controller 7111. With operation keys or a touch panel of the remote controller 7111, channels and volume can be controlled and images displayed on the display portion 7000 can be controlled.

Note that the television device 7100 is provided with a receiver, a modem, and the like. With use of the receiver, general television broadcasting can be received. When the television device is connected to a communication network with or without wires via the modem, one-way (from a transmitter to a receiver) or two-way (between a transmitter and a receiver or between receivers) data communication can be performed.

The television device 7100 may be provided with a player 7120 such as a Blu-ray player or a DVD player. The player 7120 includes a tray 7121 and an operation switch 7122. A disc 7123 such as a Blu-ray disc or a DVD disc can be stored in the tray 7121. When the disc 7123 is stored in the tray 7121, an image stored in the disc 7123 can be displayed on the display portion 7000. Furthermore, image data stored in a memory device incorporated in the television device 7100 can be upconverted with the semiconductor device which operates by an image processing method of one embodiment of the present invention, and the upconverted image data can be written to the disc 7123.

FIG. 25(B) illustrates an example of a laptop personal computer. A laptop personal computer 7200 includes a housing 7211, a keyboard 7212, a pointing device 7213, an external connection port 7214, and the like. In the housing 7211, the display portion 7000 is incorporated.

When the semiconductor device which operates by an image processing method of one embodiment of the present invention is used in the laptop personal computer 7200, the display portion 7000 can display a high-quality image.

FIG. 25(C) illustrate examples of digital signage.

A digital signage 7300 illustrated in FIG. 25(C) includes a housing 7301, the display portion 7000, a speaker 7303, and the like. Also, the digital signage 7300 can include an LED lamp, operation keys (including a power switch or an operation switch), a connection terminal, a variety of sensors, a microphone, and the like.

When the semiconductor device which operates by an image processing method of one embodiment of the present invention is used in the digital signage 7300, the display portion 7000 can display a high-quality image.

A larger area of the display portion 7000 can provide more information at a time. In addition, the larger display portion 7000 attracts more attention, so that the effectiveness of the advertisement can be increased, for example.

The use of a touch panel in the display portion 7000 is preferable because in addition to display of a still image or a moving image on the display portion 7000, intuitive operation by a user is possible. Furthermore, usability can be enhanced by intuitive operation in the case where it is used for providing information such as route information or traffic information.

Furthermore, as illustrated in FIG. 25(C), it is preferable that the digital signage 7300 work with an information terminal 7311 such as a smartphone a user has through wireless communication. For example, information of an advertisement displayed on the display portion 7000 can be displayed on a screen of the information terminal 7311. Moreover, by operation of the information terminal 7311, a displayed image on the display portion 7000 can be switched.

Furthermore, it is possible to make the digital signage 7300 execute a game with use of the screen of the information terminal 7311 as an operation means (controller). Thus, an unspecified number of people can join in and enjoy the game concurrently.

The display system of one embodiment of the present invention can be incorporated along a curved inside/outside wall surface of a house or a building or a curved interior/exterior surface of a vehicle.

This embodiment can be combined with the description of the other embodiments as appropriate.

### Example 1

In this example, display results in the case where upconversion was performed by the method described in Embodiment 1 and an image corresponding to image data that had been subjected to the upconversion was displayed are described.

In this example, image data was upconverted according to the procedure shown in FIG. 1 and FIG. 2. The number of learnings was 2000. In other words, learning was performed until i shown in FIG. 2 reached 2000. The resolution of the image data IMG was 96×96, and the resolution of the image data DCIMG was 48×48. Furthermore, the resolution of the image data UCIMG was 192×192.

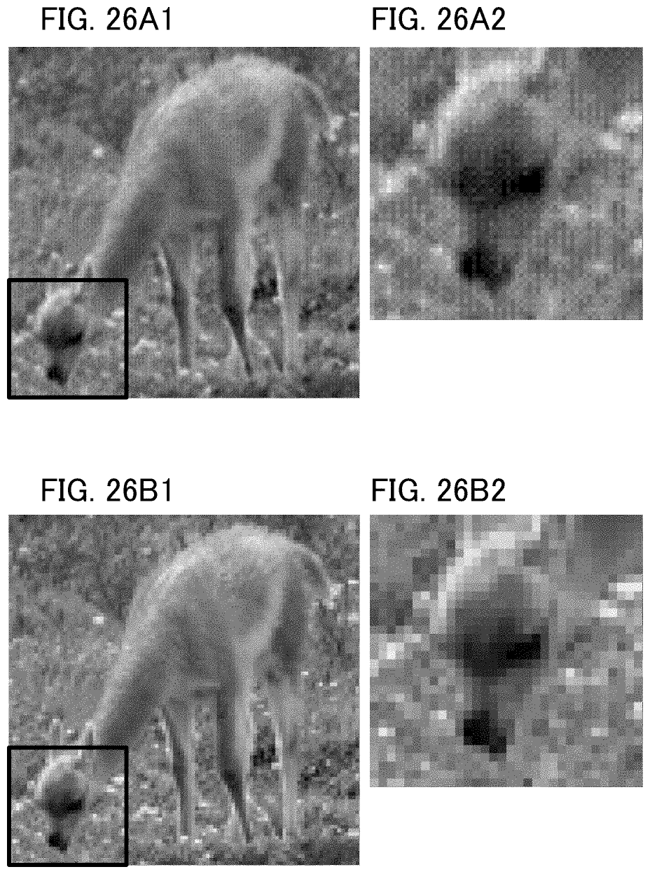

FIG. 26(A1) shows a display result of the image corresponding to the image data UCIMG obtained by upconversion, and FIG. 26(B1) shows a display result of the image corresponding to the image data IMG before upconversion. Furthermore, FIG. 26(A2) is an enlarged view of a portion surrounded by a solid line in FIG. 26(A1), and FIG. 26(B2) is an enlarged view of a portion surrounded by a solid line in FIG. 26(B1).

The image shown in FIGS. 26(A1) and 26(A2) has higher image quality than the image shown in FIGS. 26(B1) and 26(B2). For example, as shown in FIG. 26(A2), it was confirmed that the image obtained by upconversion represents a contour of a deer's face and the like more clearly without blurs than the image before upconversion shown in FIG. 26(B2). It was also confirmed that the image obtained by upconversion represents the shape of a deer's nose and the like with a higher definition than the image before upconversion. Thus, it was confirmed that upconversion of image data is possible by following the procedure shown in FIG. 1 and FIG. 2.

### REFERENCE NUMERALS

111: substrate, 113: substrate, 115: pixel, 121: overcoat, 125a: polarizing plate, 125b: polarizing plate, 131: coloring layer, 132: light-blocking layer, 133a: alignment film, 133b: alignment film, 141: bonding layer. 162: FPC, 170: light-emitting element, 171: pixel electrode, 172: EL layer, 173: common electrode, 174: bonding layer, 175: insulating layer, 180: liquid crystal element, 181: pixel electrode, 182: common electrode, 183: liquid crystal layer. 200a: transistor. 200b: transistor. 201a: transistor. 201b: transistor, 201c: transistor, 201d: transistor, 211: insulating layer, 212: insulating layer, 213: insulating layer, 215: insulating layer, 216: insulating layer, 217: insulating layer, 218: insulating layer, 220: insulating layer, 221: conductive layer, 222a: conductive layer, 222b: conductive layer. 223: conductive layer, 225: insulating layer, 231: semiconductor layer, 232: impurity semiconductor layer, 235: display region, 242: connector, 251: transistor, 251a: transistor, 251b: transistor, 255: conductive layer, 411: insulating surface, 431: conductive layer, 432: semiconductor layer, 432_1: semiconductor layer, 432_2: semiconductor layer, 432p: semiconductor layer, 433: capacitor, 433a: conductive layer, 433b: conductive layer, 434: insulating layer, 435: impurity semiconductor layer, 436: insulating layer, 436a: insulating layer, 436b: insulating layer, 437: semiconductor layer, 438: pixel circuit, 442: display element, 444: transistor, 445: node. 446: transistor, 446a: transistor, 446c: transistor, 446d: transistor, 447: node, 453: opening, 484: insulating layer, 484a: insulating layer, 485: insulating layer, 486: conductive layer, 552: backlight unit, 562: display portion, 564: scan line driver circuit, 565: conductive layer, 7000: display portion, 7100: television device, 7101: housing, 7103: stand, 7111: remote controller, 7120: player. 7121: tray, 7122: operation switch, 7123: disc, 7200: laptop personal computer, 7211: housing, 7212: keyboard, 7213: pointing device, 7214: external connection port, 7300: digital signage, 7301: housing, 7303: speaker, 7311: information terminal

1. An image processing method comprising the steps of:
preparing a first image data;
generating a second image data by decreasing a resolution of the first image data;
generating a third image data having a higher resolution than the second image data by inputting the second image data to a neural network;
calculating an error between the third image data and the first image data by comparing the first image data and the third image data; and
modifying a weight coefficient of the neural network on the basis of the error.

2. The image processing method according to claim 1, wherein resolution of the third image data is lower than or equal to the resolution of the first image data.

3. The image processing method according to claim 1, wherein the resolution of the second image data is 1/m² (m is an integer more than or equal to 2) of a resolution of the first image data.

4. The image processing method according to claim 3, further comprising the step of:
converting the first image data into a fourth image data having a higher resolution than the first image data.

5. A semiconductor device comprising:
a first circuit configured to retain a first image data;
a second circuit configured to generate a second image data by decreasing a resolution of the first image data; and
a third circuit configured to generate a third image data by increasing a resolution of the second image data using a parameter of the third circuit and to modify the parameter,
wherein the second circuit is further configured to calculate an error between the third image data and the first image data, and
wherein modifying the parameter of the third circuit is performed on the basis of the error.

6. The semiconductor device according to claim 5,
wherein the third circuit comprises a neural network, and
wherein the parameter is a weight coefficient of the neural network.

7. The semiconductor device according to claim 5,
wherein a resolution of the third image data is lower than or equal to the resolution of the first image data.

8. The semiconductor device according to claim 5,
wherein a resolution of the second image data is 1/m² (m is an integer more than or equal to 2) of the resolution of the first image data.

9. The semiconductor device according to claim 8,
wherein the third circuit is further configured to convert the first image data into a fourth image data having a higher resolution than the first image data,
wherein a resolution of the fourth image data is n² times (n is an integer more than or equal to 2) the resolution of the first image data, and
wherein m is an equal value to n.

10. An electronic device comprising:
the semiconductor device according to claim 5; and
a display portion.

11. The image processing method according to claim 4,
wherein a resolution of the fourth image data is n² times (n is an integer more than or equal to 2) the resolution of the first image data, and
wherein m is an equal value to n.

12. The image processing method according to claim 11, wherein the fourth image data is converted after modifying the weight coefficient of the neural network plural times.

13. The semiconductor device according to claim 9,
wherein the first image data is converted into the fourth image data after modifying the parameter plural times.
